(19) United States
(12) Patent Application Publication
(10) Pub. No.: US 2024/0291946 A1
(43) Pub. Date: Aug. 29, 2024

(54) TRAILER TRACKING APPARATUS, TRAILER TRACKING SYSTEM, AND TRAILER TRACKING METHOD

(71) Applicant: PANASONIC INTELLECTUAL PROPERTY MANAGEMENT CO., LTD., Osaka (JP)

(72) Inventors: Tsuyoshi NAKAMURA, Fukuoka (JP); Tadanori TEZUKA, Fukuoka (JP); Yoshiteru TANAKA, Fukuoka (JP); Takeshi YOSHIHARA, Fukuoka (JP); Tomohiro MORIKAWA, Fukuoka (JP); Masao HAMADA, Fukuoka (JP); Maiko TARUKI, Fukuoka (JP); Hiroto TOMITA, Fukuoka (JP); Shuzo NORIDOMI, Fukuoka (JP)

(73) Assignee: PANASONIC INTELLECTUAL PROPERTY MANAGEMENT CO., LTD., Osaka (JP)

(21) Appl. No.: 18/587,454

(22) Filed: Feb. 26, 2024

(30) Foreign Application Priority Data
Feb. 27, 2023 (JP) 2023-028914

(51) Int. Cl. H04N 7/18; G06F 16/51; G06F 16/54; G06T 7/292; G06T 7/70; G06V 20/52; G06V 20/62

(52) U.S. Cl. CPC H04N 7/181; G06F 16/51; G06F 16/54; G06T 7/292; G06T 7/70; G06V 20/52; G06V 20/62; G06T 2207/30241

(57) ABSTRACT

There are provided a trailer tracking apparatus, a trailer tracking method, and a trailer tracking system. The trailer tracking apparatus includes: an acquisition unit configured to acquire, from at least one camera configured to capture an image of a predetermined movement path of a trailer in a yard, a captured image of the camera; a database configured to store identification information on the trailer and information on a position of the trailer in the yard based on the captured image of the camera in association with each other; and a visualization processing unit configured to output information on a current position of the trailer specified by a visualization instruction from an external browser apparatus to the external browser apparatus based on the database.

### CROSS-REFERENCE TO RELATED APPLICATIONS

This application is based on and claims priority under 35 USC 119 from Japanese Patent Application No. 2023-028914 filed on Feb. 27, 2023, the contents of which are incorporated herein by reference.

### TECHNICAL FIELD

The present disclosure relates to a trailer tracking apparatus, a trailer tracking system, and a trailer tracking method.

### BACKGROUND ART

JP2020-098590A discloses a moving object tracking apparatus including one or more target area cameras that capture an image of a target area, a recognition unit that recognizes, based on an image captured by the target area cameras, a unique identification code displayed on a moving object moving in the target area, an image position acquisition unit that acquires a position of the moving object in the target area based on the captured image, and a position processing unit that determines identity of the moving object based on the recognized identification code and records a temporal change in the position of the moving object in a recording unit. The target area camera includes, for example, an entrance camera that captures an image when the moving object enters the target area. The moving object tracking apparatus exemplifies a work site as the target area and a worker as the moving object, respectively, and performs action tracking of the worker wearing a helmet to which the identification code is attached in the work site.

In JP2020-098590A, it is assumed that the moving object to be a target for recording the temporal change in the position is a human (the worker who moves in the work site). Therefore, it is easy to track the temporal change in the position of the worker. In some cases, tracking may be difficult when the moving object to be the target for recording the temporal change in the position is other than a human (for example, an object such as a load).

For example, it is assumed that the moving object to be the target for recording the temporal change in the position is a trailer in a wide business office (hereinafter, may be referred to as a “yard”) such as a transportation company in which a tractor (so-called transportation truck) for towing a trailer (an example of an object to be towed) on which a large amount of baggage is loaded is stacked. In this case, the transportation truck (in other words, the tractor) parks the trailer in a designated parking space in the yard when a driver who drives the tractor enters (checks in) the yard. Thereafter, an in-yard worker (hereinafter, may be referred to as “yard jockey”) who is a person different from the driver of the tractor may ride on the same tractor, tow another designated tractor, and then exit (check out) outside the yard. When the driver and the yard jockey are different persons, the parking space of the trailer in which the driver considers parking may not match the parking space the yard jockey heads for. That is, the yard jockey cannot find a target trailer even when moving toward the parking space designated by boarding the tractor. In particular, in a case where the yard has a wide site, it is often difficult for the yard jockey to visually find the target trailer. Therefore, there is a demand for a technique capable of visualizing the position of each trailer parked in the yard as necessary.

### SUMMARY OF INVENTION

The present disclosure is made in view of the above-described circumstances, and an object of the present disclosure is to provide a trailer tracking apparatus, a trailer tracking system, and a trailer tracking method for efficiently assisting a worker in a yard to easily visualize the position of a target trailer.

According to an illustrative aspect of the present disclosure, a trailer tracking apparatus includes: an acquisition unit configured to acquire, from at least one camera configured to capture an image of a predetermined movement path of a trailer in a yard, a captured image of the camera; a database configured to store identification information on the trailer and information on a position of the trailer in the yard based on the captured image of the camera in association with each other; and a visualization processing unit configured to output information on a current position of the trailer specified by a visualization instruction from an external browser apparatus to the external browser apparatus based on the database.

According to another illustrative aspect of the present disclosure, a trailer tracking method executed by a trailer tracking apparatus communicably connected to at least one camera configured to capture an image of a predetermined movement path of a trailer in a yard, includes: acquiring a captured image of the camera from the camera; storing identification information on the trailer and information on a position of the trailer in the yard based on the captured image of the camera in the database in association with each other; and outputting information on a current position of the trailer specified by a visualization instruction from an external browser apparatus to the external browser apparatus based on the database.

According to another illustrative aspect of the present disclosure, a trailer tracking system includes: at least one camera configured to capture an image of a predetermined movement path of a trailer in a yard; an acquisition unit configured to acquire a captured image of the camera; a database configured to store identification information on the trailer and information on a position of the trailer in the yard based on the captured image of the camera in association with each other; and a visualization processing unit configured to output information on a current position of the trailer specified by a visualization instruction from an external browser apparatus to the external browser apparatus based on the database.

According to the present disclosure, it is possible to efficiently assist the worker in the yard to easily visualize the position of the target trailer.

### BRIEF DESCRIPTION OF DRAWINGS

FIG. 1 is a diagram schematically showing an atmosphere of a yard.

FIG. 2 is an overhead view showing an arrangement example of cameras attached to the yard.

FIG. 3 is a diagram showing an example of a captured image of a license plate reading camera.

FIG. 4 is a diagram showing an example of a captured image of a trailer ID reading camera.

FIG. 5 is a block diagram schematically showing a system configuration example of a trailer tracking system.

FIG. 6A is a diagram showing a configuration example of an ID database.

FIG. 6B is a diagram showing a configuration example of a moving line database.

FIG. 6C is a diagram showing a configuration example of a pairing database.

FIG. 6D is a diagram showing a configuration example of an expected value database.

FIG. 7 is a view schematically showing an example of a use case of a movement trajectory (moving line) of a trailer in the yard.

FIG. 8 is a diagram showing a specific example of each database for each situation corresponding to the use case in FIG. 7.

FIG. 9 is a diagram showing a specific example of each database for each situation corresponding to the use case in FIG. 7.

FIG. 10 is a diagram showing a specific example of each database for each situation corresponding to the use case in FIG. 7.

FIG. 11 is a diagram showing a specific example of each database for each situation when an abnormal situation occurs in the situation corresponding to the use case in FIG. 7.

FIG. 12 is a diagram schematically showing a first moving line example of a trailer checked in the yard.

FIG. 13 is a diagram showing an example of a mapping display screen for visualizing that the trailer of FIG. 12 is parked at a correct position as instructed, displayed on a displayer.

FIG. 14 is a diagram showing an example of a mapping display screen for visualizing that the trailer of FIG. 12 is parked at an incorrect position different from the instruction, displayed on the displayer.

FIG. 15 is a diagram schematically showing a second moving line example of the trailer checked in the yard.

FIG. 16 is a diagram showing an example of a mapping display screen for visualizing that the trailer of FIG. 15 is parked at a correct position as instructed, displayed on the displayer.

FIG. 17 is a diagram showing an example of a mapping display screen for visualizing that the trailer of FIG. 15 is parked at an incorrect position different from the instruction, displayed on the displayer.

FIG. 18 is a sequence diagram showing, in time series, an operation procedure from check-in of the trailer to pairing processing of trailer information in a trailer tracking system according to the present embodiment.

FIG. 19 is a sequence diagram showing, in time series, an operation procedure of visualizing a position and a moving line of the trailer of the trailer tracking system according to the present embodiment.

FIG. 20A is a block diagram showing a detailed functional configuration example of a trailer moving line extraction unit according to a modification.

FIG. 20B is a diagram showing a configuration example of a moving line database according to the modification.

FIG. 20C is a diagram showing a configuration example of a pairing database according to the modification.

FIG. 21 is a diagram showing a first visualization example of a position of a trailer checked in a yard, displayed on a displayer according to the modification.

FIG. 22 is a diagram showing a second visualization example of a position of the trailer checked in the yard, displayed on the displayer according to the modification.

FIG. 23 is a diagram showing a third visualization example of a position of the trailer checked in the yard, displayed on the displayer according to the modification.

FIG. 24 is a diagram showing a fourth visualization example of a position of the trailer checked in the yard, displayed on the displayer according to the modification.

### DESCRIPTION OF EMBODIMENTS

Hereinafter, embodiments specifically disclosing a trailer tracking system and a trailer tracking method according to the present disclosure will be described in detail with reference to the drawings as appropriate. However, unnecessarily detailed descriptions may be omitted. For example, a detailed description of already well-known matters and a redundant description of substantially the same configuration may be omitted. This is to avoid unnecessary redundancy of the following description and to facilitate understanding of a person skilled in the art. It should be noted that the accompanying drawings and the following description are provided for a person skilled in the art to fully understand the present disclosure, and are not intended to limit the subject matter described in the claims.

### 1. Definition of Terms

First, terms used in the following embodiments are defined.

(1) A trailer is a container-shaped object that has a rectangular shaped enclosure in which one or more pieces of baggage are stacked and is towed by a tractor. The trailer has identification information (“trailer identification (ID)”) for identifying the trailer.

(2) A tractor is an object of a vehicle part of a transportation truck that can be docked (coupled) with or separated from the trailer. The tractor has identification information (“tractor ID”) for identifying the tractor.

(3) A yard is a wide vast business office or site such as a transportation company in which a tractor (so-called transportation truck) for towing a trailer is accumulated.

(4) A yard jockey is a worker who performs a business in the yard, such as driving the tractor in the yard and docking a target trailer in a designated parking space to the tractor, and moving the target track to a dock. It should be noted that the yard jockey may perform the work of unloading and loading baggage from the trailer that is moved to the dock. In the present embodiment, the yard jockey and a driver of a transportation truck who checks in the yard or a driver of a transportation truck who checks out outside the yard are treated as different persons.

### First Embodiment

### 2. Schematic Description of Yard

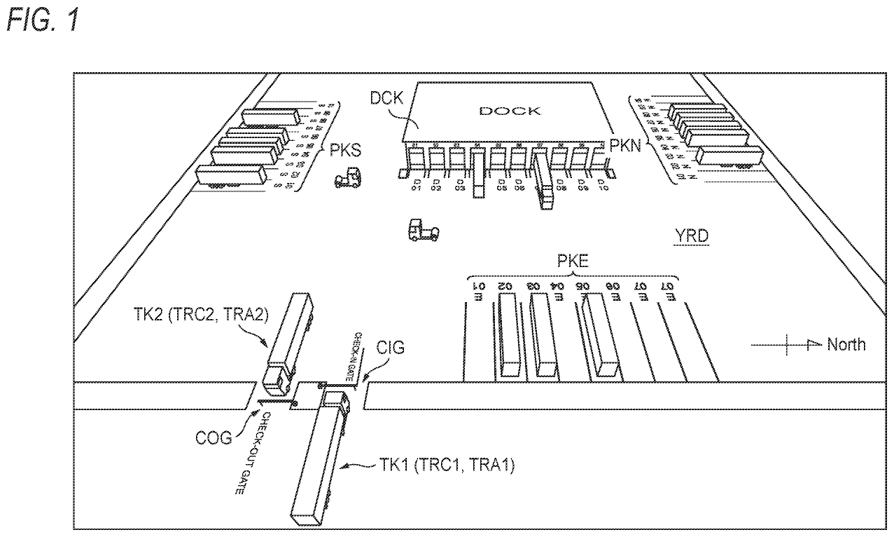

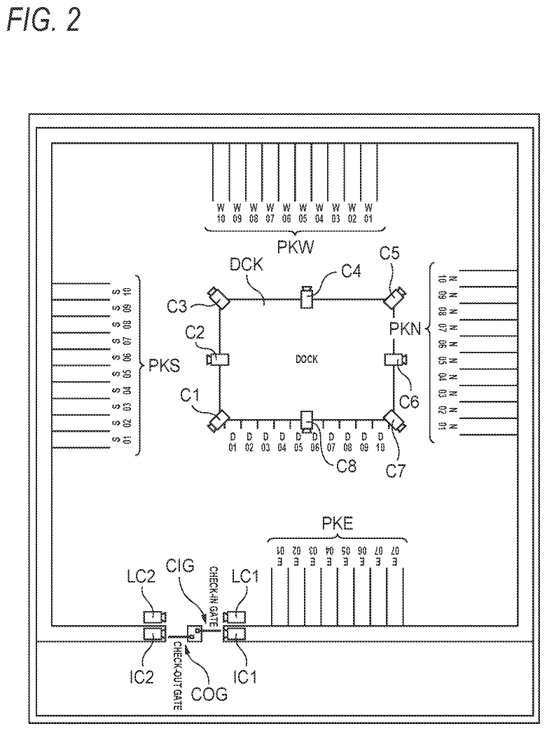

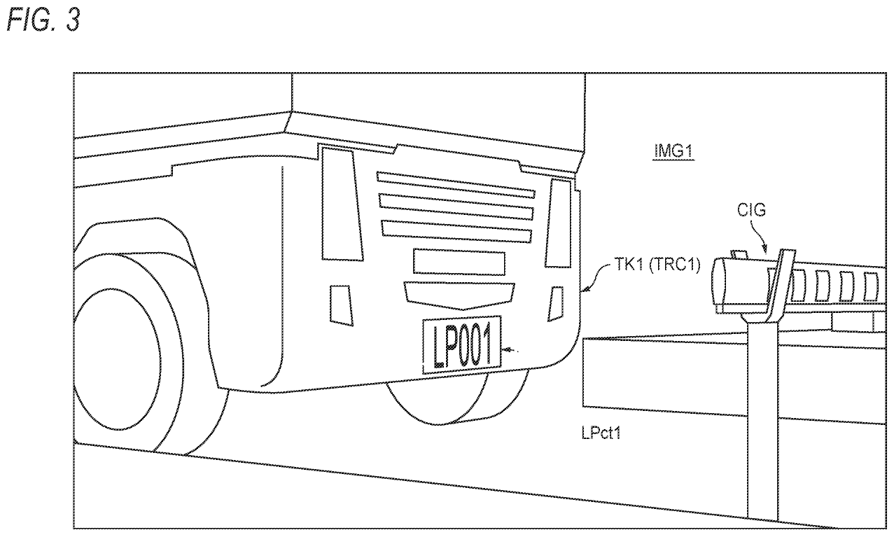

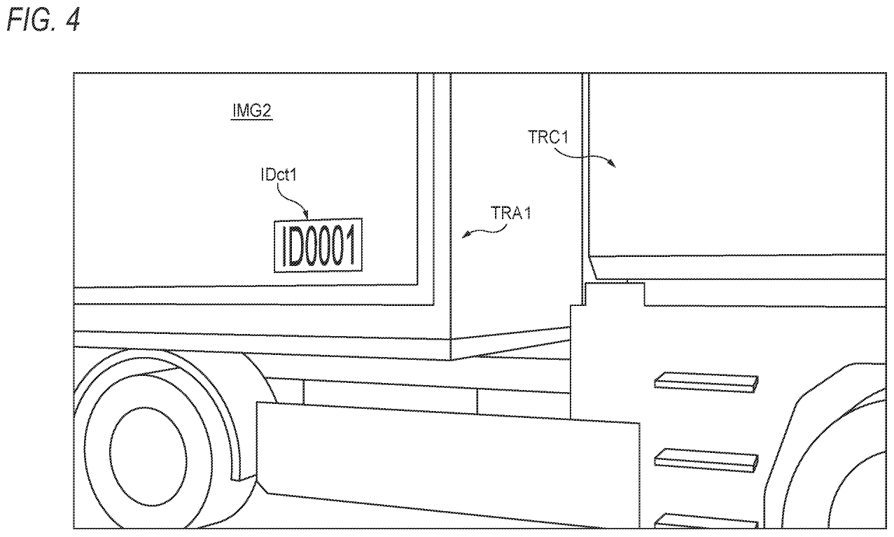

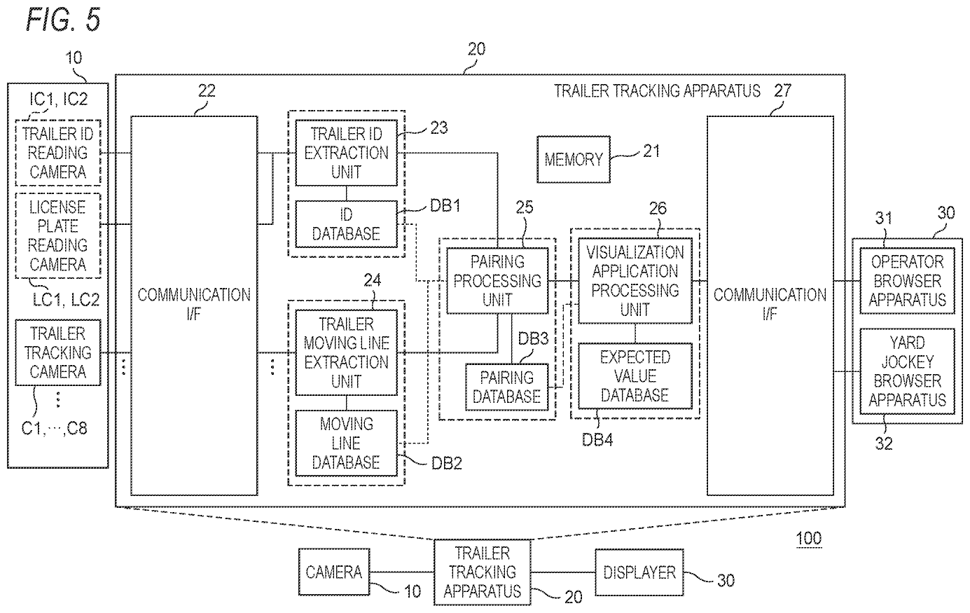

First, a yard YRD to which a trailer tracking system 100 (see FIG. 5) according to the present embodiment is introduced will be schematically described with reference to FIGS. 1 to 4. FIG. 1 is a diagram schematically showing an atmosphere of the yard YRD. FIG. 2 is an overhead view showing an arrangement example of cameras attached to the yard YRD. FIG. 3 is a diagram showing an example of a captured image of a license plate reading camera LC1. FIG. 4 is a diagram showing an example of a captured image of a trailer ID reading camera IC1.

As shown in FIGS. 1 and 2, the yard YRD is a wide site (for example, a rectangular site viewed from above the yard YRD) possessed by a company such as a transportation company.

Specifically, the yard YRD includes at least a check-in gate CIG, a check-out gate COG, a plurality of parking spaces (for example, parking spaces PKN, PKS, PKE, and PKW), and a dock station (so-called dock DCK) in the site thereof. The check-in gate CIG is a place through which a transportation truck TK1 (for example, a tractor TRC1 towing a trailer TRA1) passes when entering the yard YRD. The check-out gate COG is a place through which a transportation truck TK2 (for example, a tractor TRC2 towing a trailer TRA2) passes when exiting outside the yard YRD.

Each of the parking spaces PKN, PKS, PKE, and PKW is a space for parking one or more trailers and is spaced apart. In the example in FIG. 1, the parking space PKN has a total of five trailers parked, the parking space PKS has a total of five trailers parked, and the parking space PKE has a total of three trailers parked. The number of trailers that can be parked in each parking space may be determined in advance or may be appropriately increased according to actual operation. In each parking space, white lines for distinguishing one trailer that can be parked are provided according to the number of trailers capable of parking.

The dock DCK is a place where the yard jockey drives the tractor, tows and moves a target trailer in the parking space, and parks the target trailer or a place where the yard jockey drives the tractor and moves and parks the tractor alone without towing the trailer. In the dock DCK, for example, the yard jockey unloads baggage in the trailer from the trailer and loads the baggage into the dock DCK, or loads baggage to be newly stacked from the dock DCK into the trailer. In the dock DCK, the yard jockey may dock a trailer parked at the dock DCK to the tractor.

As shown in FIG. 2, a license plate reading camera LC1 and a trailer ID reading camera IC1 (an example of a first camera) are arranged near the check-in gate CIG (an example of an entrance) of the yard YRD. Each of the license plate reading camera LC1 and the trailer ID reading camera IC1 communicates data with the trailer tracking apparatus 20 (see FIG. 5). The license plate reading camera LC1 captures an image of a license plate LPct1 (see FIG. 3) of the transportation truck TK1 about to enter the yard YRD and sends data of the captured image IMG1 (see FIG. 3) to the trailer tracking apparatus 20 (see FIG. 5). On the other hand, the trailer ID reading camera IC1 captures an image of identification information IDct1 (see FIG. 4) of the trailer TRA1 of the transportation truck TK1 about to enter the yard YRD and sends the captured image IMG2 (see FIG. 4) to the trailer tracking apparatus 20 (see FIG. 5).

A license plate reading camera LC2 and a trailer ID reading camera IC2 (an example of the first camera) are arranged near the check-out gate COG (an example of an exit) of the yard YRD. Each of the license plate reading camera LC2 and the trailer ID reading camera IC2 communicates data with the trailer tracking apparatus 20 (see FIG. 5). The license plate reading camera LC2 captures an image of a license plate of the transportation truck TK2 about to exit outside the yard YRD and sends data of the captured image to the trailer tracking apparatus 20 (see FIG. 5). On the other hand, the trailer ID reading camera IC2 captures an image of identification information of the trailer of the transportation truck TK2 about to exit outside the yard YRD and sends the captured image to the trailer tracking apparatus 20 (see FIG. 5).

In addition, at least one trailer tracking camera C1, C2, C3, C4, C5, C6, C7, and C8 (examples of a second camera) that captures an image of a predetermined movement path of the trailer in the yard YRD is arranged in a zenith portion such as a roof of a building of the dock DCK. Each of the trailer tracking cameras C1, C2, C3, C4, C5, C6, C7, and C8 communicates data with the trailer tracking apparatus 20 (see FIG. 5). Each of the trailer tracking cameras C1, C2, C3, C4, C5, C6, C7, and C8 captures an image of an object to be imaged (for example, a trailer) within an angle of view of the own device, and sends data of the captured image to the trailer tracking apparatus 20 (see FIG. 5).

As shown in FIG. 3, the license plate reading camera LC1 periodically captures an image in which a front portion of the tractor TRC1 of the transportation truck TK1 near the check-in gate CIG is the object to be imaged. In the captured image IMG1 obtained by this capturing, the license plate LPct1 which is identification information of the transportation truck TK1 is shown. The captured image IMG1 is sent from the license plate reading camera LC1 to the trailer tracking apparatus 20. The trailer tracking apparatus 20 detects the license plate LPct1 by analyzing the captured image IMG1 from the license plate reading camera LC1, and extracts information on the license plate LPct1. A method of detecting the license plate LPct1 may be a known technique, a detailed explanation is omitted here, and the method of detecting the license plate LPct1 may be executed by a learning model formed by machine learning using a large amount of learning data and artificial intelligence (AI).

As shown in FIG. 4, the trailer ID reading camera IC1 periodically captures an image in which a front portion of the trailer TRA1 of the transportation truck TK1 near the check-in gate CIG is the object to be imaged. In the captured image IMG2 obtained by this capturing, the identification information IDct1 of the trailer TRA1 which is towed by the tractor TRC1 of the transportation truck TK1 is shown. The captured image IMG2 is sent from the trailer ID reading camera IC1 to the trailer tracking apparatus 20. The trailer tracking apparatus 20 detects the identification information IDct1 of the trailer TRA1 by analyzing the captured image IMG2 from the trailer ID reading camera IC1 and extracts the identification information IDct1. Hereinafter, the identification information of the trailer may be abbreviated as “trailer ID”. A method of detecting the identification information may be a known technique, a detailed explanation is omitted here, and the method of detecting the identification information may be executed by a learning model formed by machine learning using a large amount of learning data and AI.

### 3. System Configuration of Trailer Tracking System

Next, a system configuration example of a trailer tracking system 100 according to the present embodiment will be described in detail with reference to FIG. 5. FIG. 5 is a block diagram schematically showing the system configuration example of the trailer tracking system 100. The trailer tracking system 100 according to the present embodiment includes a camera 10, a trailer tracking apparatus 20, and a displayer 30. Between the camera 10 and the trailer tracking apparatus 20, and between the trailer tracking apparatus 20 and the displayer 30, data communication is possible via a network.

The network in the present disclosure is any one of a wired network, a wireless network, or a combination of a wired network and a wireless network. The wired network corresponds to, for example, at least one of a wired local area network (LAN), a wired wide area network (WAN), and power line communication (PLC), and may have another network configuration capable of wired communication. On the other hand, the wireless network corresponds to at least one of a wireless LAN such as Wi-Fi (registered trademark), a wireless WAN, and a mobile communication network such as 4G or 5G, and may have another network configuration capable of wireless communication.

The camera 10 captures the image of the predetermined movement path of the trailer in the yard YRD. The camera 10 includes, for example, the license plate reading cameras LC1 and LC2, the trailer ID reading cameras IC1 and IC2, and the trailer tracking cameras C1 to C8. Other cameras may be arranged as the camera 10. For example, the camera 10 may include a drone (not shown) capable of taking an aerial photograph of the yard YRD from above or a device capable of capturing a satellite photograph from above.

The trailer tracking apparatus 20 detects (tracks) a temporal change in a position of a predetermined trailer that moves along the predetermined movement path in the yard YRD using the data of the captured image from the camera 10, and stores data of a detection result. The trailer tracking apparatus 20 may be, for example, a personal computer or a high-performance server computer. The trailer tracking apparatus 20 includes a memory 21, a communication interface 22, a trailer ID extraction unit 23, an ID database DB1, a trailer moving line extraction unit 24, a moving line database DB2, a pairing processing unit 25, a pairing database DB3, a visualization application processing unit 26, an expected value database DB4, and a communication interface 27. In FIG. 5, an interface is abbreviated as “I/F”.

The memory 21 includes at least a read only memory (ROM) and a random access memory (RAM). The ROM stores a program that defines each processing (operation) of the trailer ID extraction unit 23, the trailer moving line extraction unit 24, the pairing processing unit 25, and the visualization application processing unit 26, and data referred to when the program is executed. The RAM is a work memory used at the time of executing the processing (operation) of the trailer ID extraction unit 23, the trailer moving line extraction unit 24, the pairing processing unit 25, and the visualization application processing unit 26, and temporarily stores data or information generated or acquired in each processing.

The communication interface 22 is an example of an acquisition unit and is implemented with a communication circuit that executes communication of data (for example, an image or a video) with various cameras 10.

When receiving the data of the captured image from various cameras 10, the communication interface 22 sends the data to the trailer ID extraction unit 23 or the trailer moving line extraction unit 24. The communication interface 22 may distribute a destination of the data of the captured image from various cameras 10 according to the camera 10 of a transmission source. For example, the communication interface 22 may send the data of the captured image from each of the trailer ID reading cameras IC1 and IC2 and the license plate reading cameras LC1 and LC2 to the trailer ID extraction unit 23 and may send the data of the captured image from each of the trailer tracking cameras C1 to C8 to the trailer moving line extraction unit 24.

Each of the trailer ID extraction unit 23, the trailer moving line extraction unit 24, the pairing processing unit 25, and the visualization application processing unit 26 is implemented with a processor such as a central processing unit (CPU), a digital signal processor (DSP), or a field programmable gate array (FPGA).

The trailer ID extraction unit 23 periodically acquires the data from the communication interface 22 (that is, the data of the captured image from each of the trailer ID reading cameras IC1 and IC2 and the license plate reading cameras LC1 and LC2). The trailer ID extraction unit 23 analyzes the data of the captured image from the trailer ID reading camera (for example, the trailer ID reading camera IC1) to periodically extract a trailer ID which is the identification information of the trailer shown in the captured image. The trailer ID extraction unit 23 stores (registers) data of an extraction result of the trailer ID obtained by the analysis in the ID database DB1 and sends the data to the pairing processing unit 25. As described above, a method of extracting the trailer ID in the analysis of the data of the captured image may be executed by a learning model formed by machine learning using a large number of learning data and AI or may be executed using a known technique such as existing pattern matching.

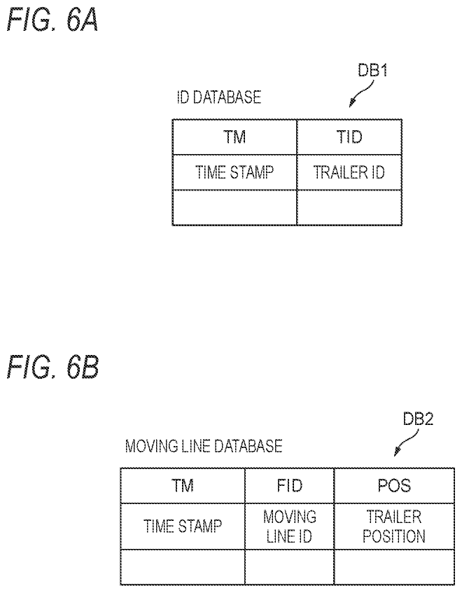

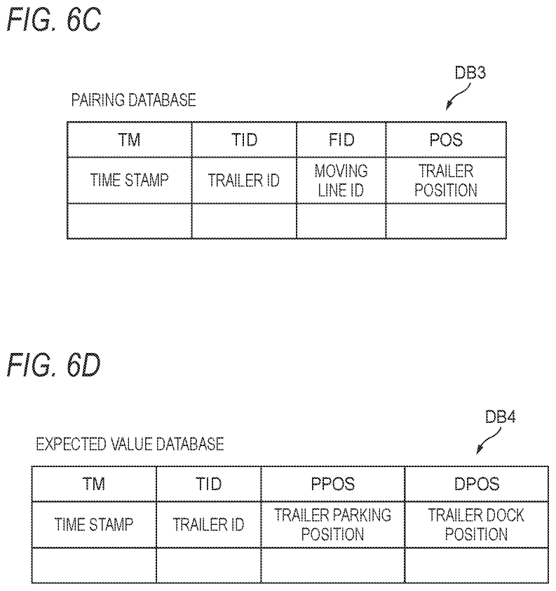

The ID database DB1 is a database that stores (registers) a time stamp (TM) indicating a time at which the trailer ID is extracted and the extracted trailer ID (TID) in association with each other (see FIG. 6A).

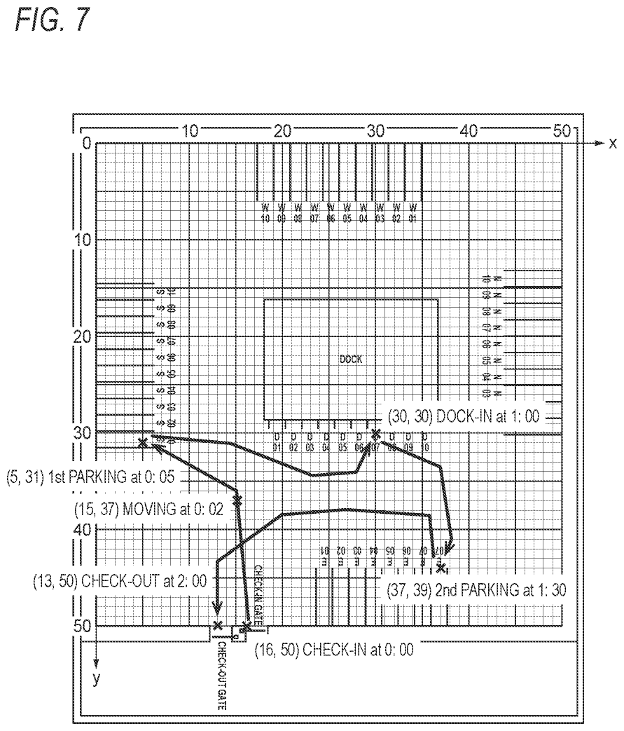

FIG. 6A is a diagram showing a configuration example of the ID database DB1. As shown in FIG. 6A, the ID database DB1 stores the time stamp (TM) and the trailer ID (TID) in association with each other. A specific example of the ID database DB1 will be described later with reference to use cases shown in FIGS. 7 to 11.

The trailer moving line extraction unit 24 periodically acquires the data from the communication interface 22 (that is, the data of the captured image from each of the trailer tracking cameras C1 to C8). The trailer moving line extraction unit 24 analyzes the data of the captured image from the trailer tracking camera (for example, the trailer tracking camera C1) to periodically extract position information that indicates the position of the trailer shown in the captured image. The trailer moving line extraction unit 24 determines, based on a predetermined determination criterion, whether the position indicated by the extracted position information forms the same moving line or a different moving line with a position indicated by position information extracted most recently (last time), and assigns a moving line ID based on a determination result. When determining that the moving line is the same moving line (that is, the same moving line as the existing moving line), the trailer moving line extraction unit 24 stores (registers) the moving line ID (FID), which is identification information of the same moving line, and the extracted position information in the moving line database DB2 in association with each other, and sends the moving line ID (FID) and the extracted position information to the pairing processing unit 25. On the other hand, when determining that the moving line is a different moving line (that is, a new moving line), the trailer moving line extraction unit 24 stores (registers) the moving line ID (FID), which is identification information of the new moving line, and the extracted position information in the moving line database DB2 in association with each other, and sends the moving line ID (FID) and the extracted position information to the pairing processing unit 25.

The determination criterion is whether the position indicated by the latest extracted position information is within a predictable range from the position indicated by the most recently extracted position information. The predictable range is a range including, in a radial shape, a position at which the trailer can be estimated to move when the trailer is extracted next time (that is, the latest time) from the position information extracted most recently (that is, the previous time) based on a speed of the trailer performing a constant linear motion when it is assumed that the trailer performs the constant linear motion. The predictable range may be derived by arithmetic processing using a predetermined function (for example, Kerman filter) in which the position information extracted most recently is input by the trailer moving line extraction unit 24.

Here, the position information of the trailer is information indicating a relative position from an origin (0, 0) in a case where xy two-dimensional coordinates are provided in the site in the yard YRD shown in FIG. 7 described later. The trailer moving line extraction unit 24 stores (registers) data of the extraction result of the position information of the trailer obtained by the analysis in the ID database DB1. As described above, a method of extracting the position information of the trailer in the analysis of the data of the captured image may be executed by a learning model formed by machine learning using a large number of learning data and AI or may be executed using a known technique such as existing pattern matching.

The moving line database DB2 is a database that stores (registers) a time stamp (TM) indicating a time at which the position information of the trailer is extracted by the trailer moving line extraction unit 24, a trailer position (POS) indicated by the extracted position information (for example, two-dimensional coordinates), and a moving line ID (FID) indicating whether the trailer position forms a new moving line or an existing moving line in association with one another (see FIG. 6B). FIG. 6B is a diagram showing a configuration example of the moving line database DB2. As shown in FIG. 6B, the moving line database DB2 stores the time stamp (TM), the moving line ID (FID), and the trailer position (POS) in association with one another. A specific example of the moving line database DB2 will be described later with reference to the use cases shown in FIGS. 7 to 11.

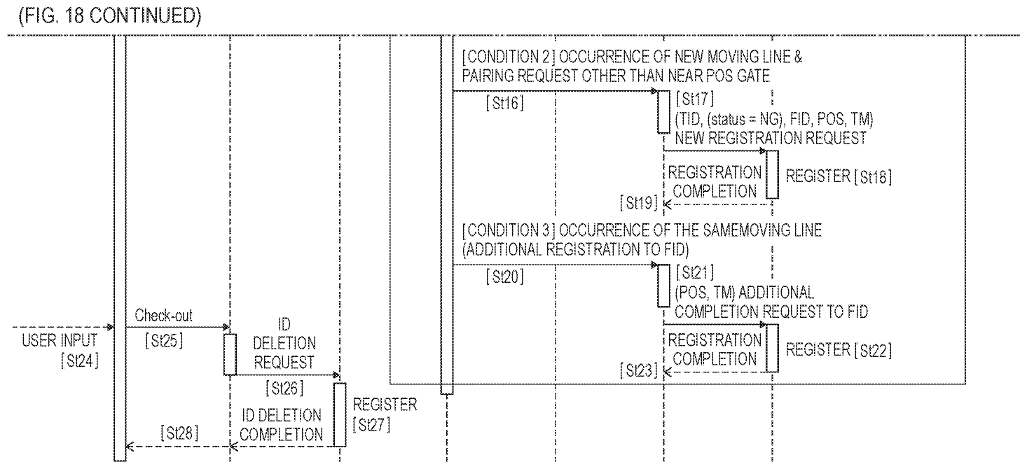

The pairing processing unit 25 acquires the data of the extraction result of the trailer ID from the trailer ID extraction unit 23 and the data of the extraction result of the position information of the trailer from the trailer moving line extraction unit 24. The pairing processing unit 25 determines whether a predetermined condition (for example, [Condition 1], [Condition 2], and [Condition 3], see FIG. 18) is satisfied based on an instruction from the trailer moving line extraction unit 24. When determining that any one of [Condition 1], [Condition 2], and [Condition 3] is satisfied, the pairing processing unit 25 pairings (associates) the data of the extraction result of the trailer ID and the data of the extraction result of the position information of the trailer to store (register) the data in the pairing database DB3. That is, the pairing processing unit 25 integrates different information (specifically, the trailer ID (TID), the trailer position (POS), and the moving line ID (FID)) extracted using the data of the captured images captured by different cameras 10 (specifically, at least one of the trailer ID reading camera IC1 and the trailer tracking cameras C1 to C8) as information related to one trailer based on information on the time stamp (TM) common to the different information.

The pairing database DB3 is a database that stores (registers) the time stamp (TM) indicating the time at which the trailer ID is extracted and the time at which the position information of the trailer is extracted, which are the same time, the extracted trailer ID (TID), the trailer position (POS) indicated by the extracted position information, and the moving line ID (FID) indicating whether the trailer position forms any one of the new moving line or the existing moving line in association with each other (see FIG. 6C). FIG. 6C is a diagram showing a configuration example of the pairing database DB3. As shown in FIG. 6C, the pairing database DB3 stores the time stamp (TM), the trailer ID (TID), the moving line ID (FID), and the trailer position (POS) in association with one another. A specific example of the pairing database DB3 will be described later with reference to the use cases shown in FIGS. 7 to 11.

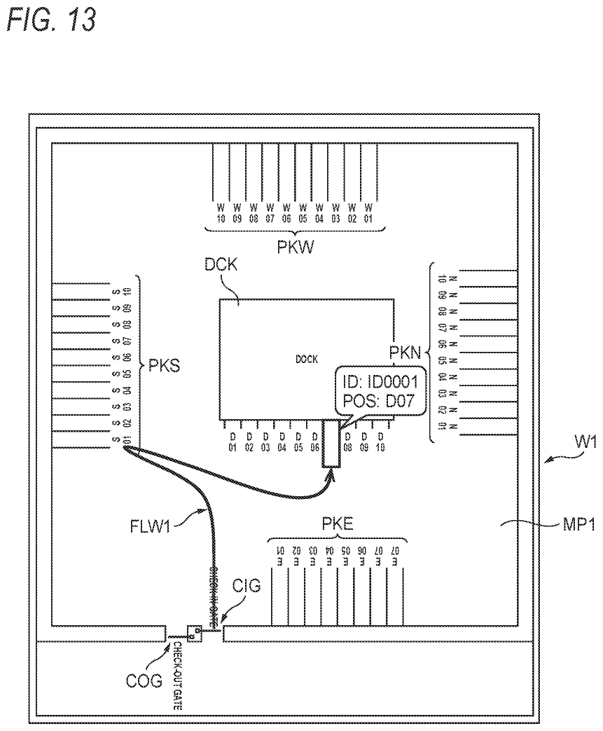

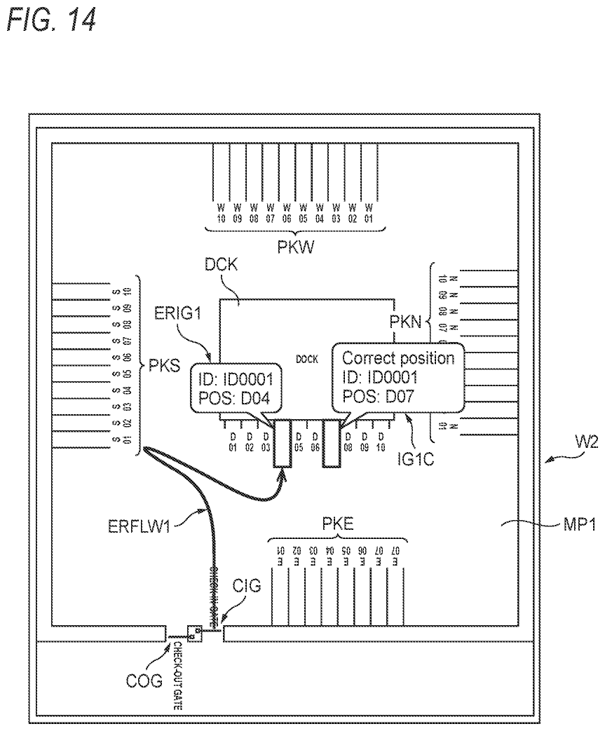

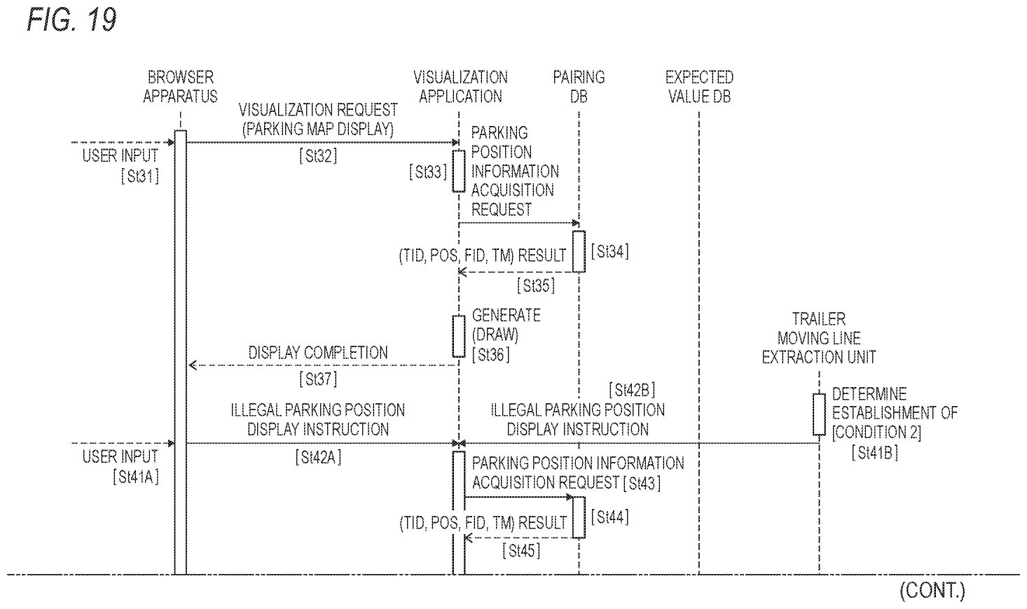

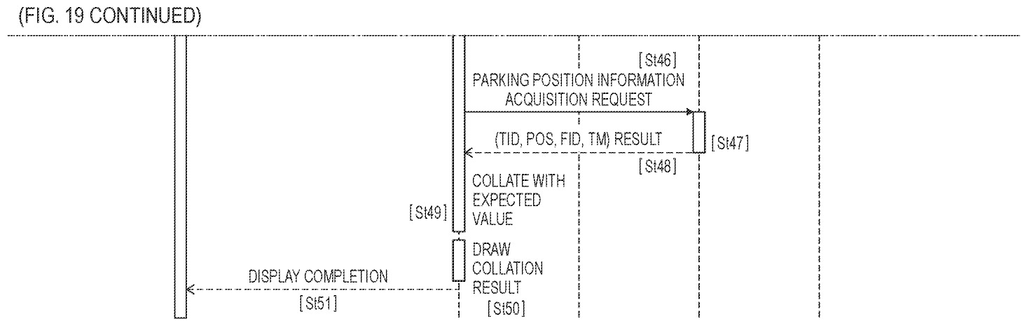

The visualization application processing unit 26 acquires a visualization request (an example of the visualization instruction) for visualizing a current trailer position (POS) via the communication interface 27 from the displayer 30. The visualization request is generated by a yard jockey browser apparatus 32 by the operation of the yard jockey or generated by an operator browser apparatus 31 by the operation of an operator who receives a notification from the yard jockey when, for example, the yard jockey is directed to the position of the target trailer designated by the operator in the yard YRD but cannot find the target trailer. The visualization request includes, for example, the trailer ID for identifying the target trailer. When acquiring the visualization request from various displayers 30, the visualization application processing unit 26 acquires the information on the current position of the trailer specified by the visualization request by inquiring the pairing processing unit 25 or acquires the information by directly accessing and referring to the pairing database DB3. The visualization application processing unit 26 generates a mapping display screen (see, for example, FIG. 13 or FIG. 14) indicating at least the current position of the trailer based on an acquisition result of the current position of the trailer in response to the visualization request and outputs (transmits) the mapping display screen to the displayer 30. The mapping display screen (see, for example, FIG. 13 or FIG. 14) is displayed on the displayer 30 so as to be visually recognizable by the operator or the yard jockey. A detailed operation procedure of the visualization application processing unit 26 will be described later with reference to FIG. 19.

The expected value database DB4 is a database that defines a position on a movement path in the yard YRD for each trailer that is to be originally observed when an operator who is a person in charge of operation and management of the dock DCK manages movement such as arrival and departure of the trailer to an appropriate dock DCK (see FIG. 6D). FIG. 6D is a diagram showing a configuration example of the expected value database DB4. As shown in FIG. 6D, the expected value database DB4 stores the time stamp (TM), the trailer ID (TID), a trailer parking position (PPOS), and a trailer dock position (DPOS) in association with one another. As the time stamp (TM), the trailer ID (TID), the trailer parking position (PPOS), and the trailer dock position (DPOS), data input by an operation of the operator using the displayer 30 (for example, the operator browser apparatus 31) capable of referring to the expected value database DB4 through the visualization application processing unit 26 may be stored (registered). A specific example of the expected value database DB4 will be described later with reference to the use cases shown in FIGS. 7 to 11. The trailer parking position (PPOS) is position information (for example, two-dimensional coordinates) of a parking space in which the checked trailer is to be parked. The trailer dock position (DPOS) is position information (for example, two-dimensional coordinates) of the dock DCK to which the trailer is to move next from the parking space.

The communication interface 27 is an example of the acquisition unit and is implemented with a communication circuit that executes communication of data (for example, the visualization request and a matching display screen) with the various displayers 30. When receiving data of the visualization request from the various displayers 30, the communication interface 27 sends the data to the visualization application processing unit 26. When receiving data of the mapping display screen from the visualization application processing unit 26, the communication interface 27 sends the data to the various displayers 30. The communication interface 27 may distribute the data of the corresponding mapping display screen according to a transmission source of the data of the visualization request from the various displayers 30 or may send the data of the corresponding mapping display screen to all the displayers 30 regardless of the transmission source of the data of the visualization request.

The displayer 30 generates the data of the visualization request of the target trailer position input by a user operation, sends the data to the trailer tracking apparatus 20, and displays the mapping display screen (see, for example, FIG. 13 or FIG. 14) indicating the target trailer position generated by the trailer tracking apparatus 20. The displayer 30 includes the operator browser apparatus 31 and the yard jockey browser apparatus 32.

The operator browser apparatus 31 is used by an administrator (operator) who is a person in charge of the yard YRD and manages the trailer tracking system 100 and is, for example, a notebook computer or a tablet terminal. The operator browser apparatus 31 may be a computer apparatus other than the notebook computer or the tablet terminal.

The yard jockey browser apparatus 32 is used by a yard jockey who is a worker working in the yard YRD and is, for example, a notebook computer or a tablet terminal. The yard jockey browser apparatus 32 may be a computer apparatus other than the notebook computer or the tablet terminal.

### 4. Use Case of Trailer Tracking System

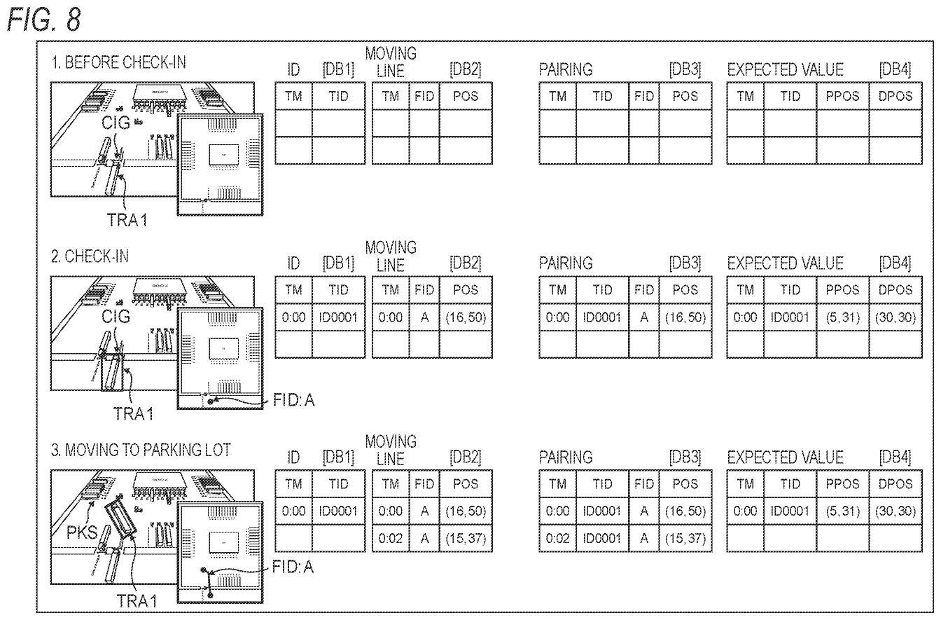

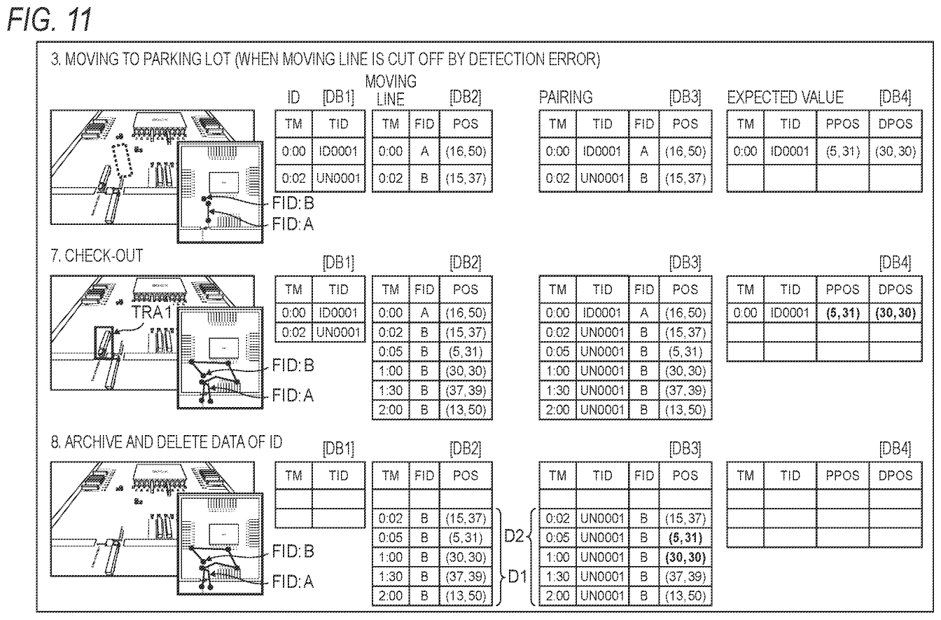

Next, an example of the use case when the trailer tracking system 100 according to the present embodiment is actually operated will be described in detail with reference to FIGS. 7 to 11. FIG. 7 is a view schematically showing the example of the use case of a movement trajectory (moving line) of the trailer in the yard. FIGS. 8, 9, and 10 are diagrams showing specific examples of each database for each situation corresponding to the use case in FIG. 7. FIG. 11 is a diagram showing a specific example of each database for each situation when an abnormal situation occurs in the situation corresponding to the use case in FIG. 7. In the description of FIGS. 8 to 10, the same configurations and contents are denoted by the same reference numerals, descriptions of overlapping contents are simplified or omitted, and different contents will be described.

When the use case of the trailer tracking system 100 according to the present embodiment is described, a two-dimensional coordinate axis (specifically, the origin, an x-axis, and a y-axis) for defining the position of the trailer in the yard YRD is shown in FIG. 7.

In the use case shown in FIG. 7, it is assumed that the next event occurs in time series.

(Event 1) At time 0:00, the trailer having a trailer ID “ID0001” passes through the check-in gate CIG (see FIG. 1) provided at a position of coordinates (16, 50) and moves toward a parking space (for example, the parking space PKS) designated by the operator. The movement of the trailer is executed in accordance with the movement of the tractor (see FIG. 1) that tows the trailer.

(Event 2) At time 0:02, the trailer having the trailer ID “ID0001” is present at a position of coordinates (15, 37) and is moving toward the parking space (for example, the parking space PKS) designated by the operator.

(Event 3) At time 0:05, the trailer having the trailer ID “ID0001” is parked at a parking space (for example, one parking space in the parking space PKS) provided at a position of coordinates (5, 31).

(Event 4) At time 1:00, the trailer having the trailer ID “ID0001” is parked at (docked in) a parking space of the dock DCK provided at a position of coordinates (30, 30).

(Event 5) At time 1:30, the trailer having the trailer ID “ID0001” is parked at a parking space (for example, one parking space in the parking space PKE) provided at a position of coordinates (37, 39).

(Event 6) At time 2:00, the trailer having the trailer ID “ID0001” passes through the check-out gate COG (see FIG. 1) provided at a position of coordinates (13, 50) and exits outside the yard YRD.

The temporal change in a series of positions of the trailer having the same trailer ID “ID0001” from (Event 1) to (Event 6) is continuously extracted. Therefore, the trailer tracking apparatus 20 assigns and manages a moving line ID “A” as the moving line ID (FID) for identifying the moving line of the trailer having the same trailer ID “ID0001” from (Event 1) to (Event 6).

In “1. BEFORE CHECK-IN” in FIG. 8, a state immediately before the trailer having the trailer ID “ID0001” passes through the check-in gate CIG of the yard YRD at a timing of “before check-in” before (Event 1) is shown. In this case, no data is written in the ID database DB1, the moving line database DB2, the pairing database DB3, and the expected value database DB4 by the trailer tracking apparatus 20.

In “2. CHECK-IN” in FIG. 8, a state is shown in which the trailer having the trailer ID “ID0001” passes through the check-in gate CIG of the yard YRD. At this time, the trailer tracking apparatus 20 detects the trailer ID “ID0001” based on the captured image captured by the trailer ID reading camera IC1 attached near the check-in gate CIG, and writes a time stamp “0:00” indicating the time at which the trailer ID “ID0001” is detected and the trailer ID “ID0001” in the ID database DB1. The trailer tracking apparatus 20 detects the position (for example, the coordinates (16, 50)) of the trailer based on the captured image captured by the trailer tracking camera (see FIG. 5) and writes the time stamp “0:00” indicating the time at which the position of the trailer is detected, the position of the trailer (for example, the coordinates (16, 50), and the moving line ID “A” indicating that the moving line of the trailer is a new moving line in the moving line database DB2 in association with one another. The trailer tracking apparatus 20 writes the time stamp “0:00”, the trailer ID “ID0001”, the moving line ID “A”, and the trailer position (for example, the coordinates (16, 50)) corresponding to the same trailer in the pairing database DB3 as a result of the pairing processing using the data having the time stamp “0:00” common to the ID database DB1 and the moving line database DB2. Further, in the expected value database DB4, a time stamp “0:00” indicating the time at which the trailer is detected, the trailer ID “ID0001”, the trailer parking position (for example, the coordinates (5, 31)) indicating a position at which the trailer is to be parked next, and the trailer dock position (for example, the coordinates (30, 30)) indicating a position of the dock DCK at which the trailer is to be moved after parking are input and stored for the trailer of the trailer ID “ID0001” by the operation of the operator using the operator browser apparatus 31.

In “3. MOVING TO PARKING LOT” in FIG. 8, a state is shown in which the trailer having the trailer ID “ID0001” is moving to a parking lot (for example, a trailer parking position corresponding to the trailer ID “ID0001” in the expected value database DB4) in the yard YRD designated by the operator. At this time, since no new trailer ID is detected, contents of the ID database DB1 are not changed to contents at the time of “2. CHECK-IN”. The trailer tracking apparatus 20 detects the position (for example, the coordinates (15, 37)) of the trailer based on the captured image captured by the trailer tracking camera (see FIG. 5), and adds and writes a time stamp “0:02” indicating the time at which the position of the trailer is detected, the position (for example, the coordinates (15, 37)) of the trailer, and the moving line ID “A” indicating that the moving line of the trailer is an existing moving line to the moving line database DB2 in association with one another at the time of “2. CHECK-IN”. The trailer tracking apparatus 20 adds and writes the time stamp “0:02”, the trailer ID “ID0001”, the moving line ID “A”, and the trailer position (for example, the coordinates (15, 37)) corresponding to the same trailer in the pairing database DB3 at the time of “2. CHECK-IN” as a result of the pairing processing using data having the time stamp “0:02” common to the ID database DB1 and the moving line database DB2. The contents input at the time of “2. CHECK-IN” are not changed to the expected value database DB4.

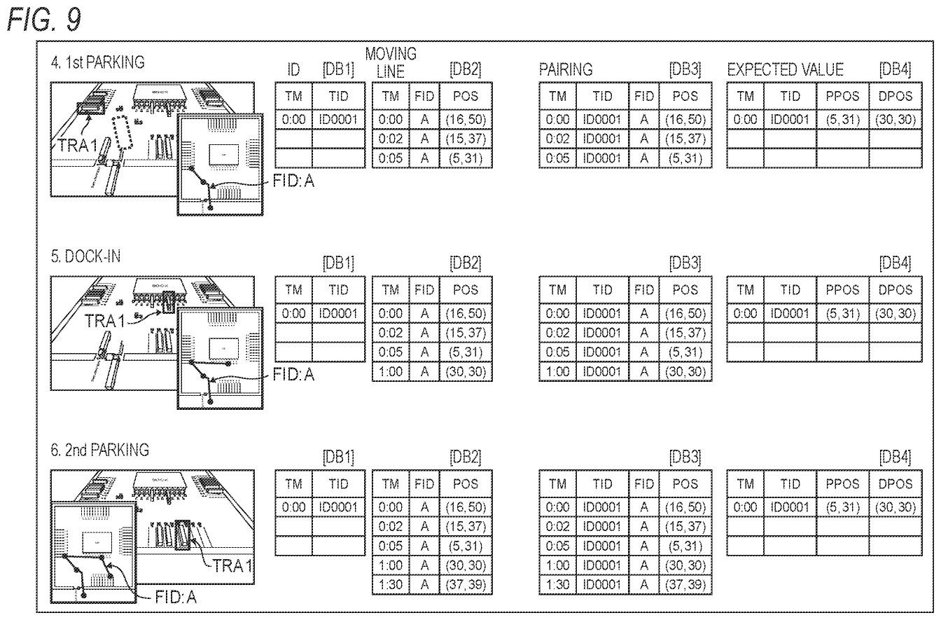

In “4. 1st PARKING” in FIG. 9, a state is shown in which the trailer having the trailer ID “ID0001” is parked in a position (for example, the trailer parking position corresponding to the trailer ID “ID0001” of the expected value database DB4) of the dock

DCK in the yard YRD designated by the operator. At this time, since no new trailer ID is detected, contents of the ID database DB1 are not changed to contents at the time of “2. CHECK-IN”. The trailer tracking apparatus 20 detects the position (for example, the coordinates (5, 31)) of the trailer based on the captured image captured by the trailer tracking camera (see FIG. 5), and adds and writes a time stamp “0:05” indicating the time at which the position of the trailer is detected, the position (for example, the coordinates (5, 31)) of the trailer, and the moving line ID “A” indicating that the moving line of the trailer is an existing moving line to the moving line database DB2 in association with one another at the time of “3. MOVING TO PARKING LOT”. The trailer tracking apparatus 20 adds and writes the time stamp “0:05”, the trailer ID “ID0001”, the moving line ID “A”, and the trailer position (for example, the coordinates (5, 31)) corresponding to the same trailer in the pairing database DB3 at the time of “3. MOVING TO PARKING LOT” as a result of the pairing processing using data having the time stamp “0:05” common to the ID database DB1 and the moving line database DB2. The contents input at the time of “2. CHECK-IN” are not changed to the expected value database DB4.

In “5. DOCK-IN” in FIG. 9, a state is shown in which the trailer having the trailer ID “ID0001” is parked in a position (for example, the trailer dock position corresponding to the trailer ID “ID0001” of the expected value database DB4) of the dock DCK in the yard YRD designated by the operator. At this time, since no new trailer ID is detected, contents of the ID database DB1 are not changed to contents at the time of “2. CHECK-IN”. The trailer tracking apparatus 20 detects the position (for example, the coordinates (30, 30)) of the trailer based on the captured image captured by the trailer tracking camera (see FIG. 5), and adds and writes a time stamp “1:00” indicating the time at which the position of the trailer is detected, the position (for example, the coordinates (30, 30)) of the trailer, and the moving line ID “A” indicating that the moving line of the trailer is an existing moving line to the moving line database DB2 in association with one another at the time of “4. 1st PARKING”. The trailer tracking apparatus 20 adds and writes the time stamp “1:00”, the trailer ID “ID0001”, the moving line ID “A”, and the trailer position (for example, the coordinates (30, 30)) corresponding to the same trailer in the pairing database DB3 at the time of “4. 1st PARKING” as a result of the pairing processing using data having the time stamp “1:00” common to the ID database DB1 and the moving line database DB2. The contents input at the time of “2. CHECK-IN” are not changed to the expected value database DB4.

In “6. 2nd PARKING” in FIG. 9, a state is shown in which the trailer having the trailer ID “ID0001” is parked in a parking lot (for example, one parking space in the parking space PKE) in the yard YRD promptly designated by the operator. At this time, since no new trailer ID is detected, contents of the ID database DB1 are not changed to contents at the time of “2. CHECK-IN”. The trailer tracking apparatus 20 detects the position (for example, the coordinates (37, 39)) of the trailer based on the captured image captured by the trailer tracking camera (see FIG. 5), and adds and writes a time stamp “1:30” indicating the time at which the position of the trailer is detected, the position (for example, the coordinates (37, 39)) of the trailer, and the moving line ID “A” indicating that the moving line of the trailer is an existing moving line to the moving line database DB2 in association with one another at the time of “5. DOCK-IN”. The trailer tracking apparatus 20 adds and writes the time stamp “1:30”, the trailer ID “ID0001”, the moving line ID “A”, and the trailer position (for example, the coordinates (37, 39)) corresponding to the same trailer in the pairing database DB3 at the time of “5. DOCK-IN” as a result of the pairing processing using data having the time stamp “1: 30” common to the ID database DB1 and the moving line database DB2. The contents input at the time of “2. CHECK-IN” are not changed to the expected value database DB4.

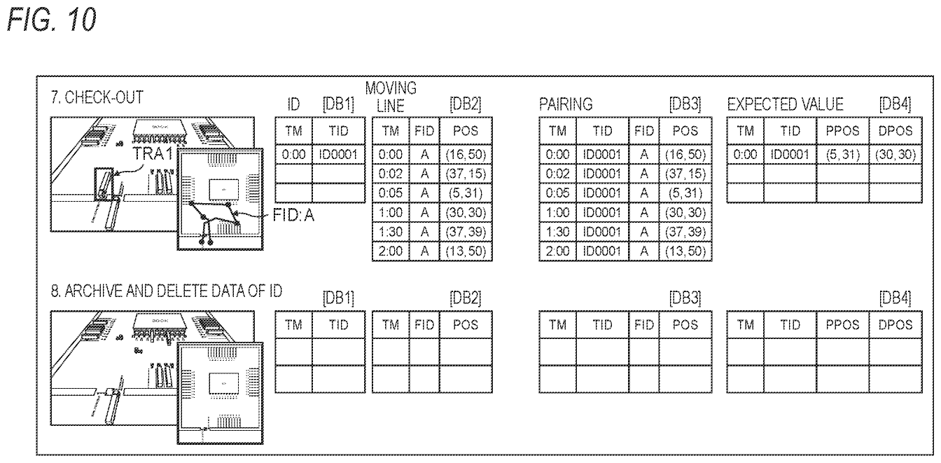

In “7. CHECK-OUT” in FIG. 10, a state is shown in which the trailer having the trailer ID “ID0001” passes through the check-out gate COG of the yard YRD. At this time, since no new trailer ID is detected, contents of the ID database DB1 are not changed to contents at the time of “2. CHECK-IN”. The trailer tracking apparatus 20 detects the position (for example, the coordinates (13, 50)) of the trailer based on the captured image captured by the trailer tracking camera (see FIG. 5), and adds and writes a time stamp “2:00” indicating the time at which the position of the trailer is detected, the position (for example, the coordinates (13, 50)) of the trailer, and the moving line ID “A” indicating that the moving line of the trailer is an existing moving line to the moving line database DB2 in association with one another at the time of “6. 2nd PARKING”.

The trailer tracking apparatus 20 adds and writes the time stamp “2:00”, the trailer ID “ID0001”, the moving line ID “A”, and the trailer position (for example, the coordinates (13, 50)) corresponding to the same trailer in the pairing database DB3 at the time of “6. 2nd PARKING” as a result of the pairing processing using data having the time stamp “2:00” common to the ID database DB1 and the moving line database DB2.

The contents input at the time of “2. CHECK-IN” are not changed to the expected value database DB4.

In “8. ARCHIVE AND DELETE DATA OF ID” in FIG. 10, the trailer tracking apparatus 20 deletes various data corresponding to the trailer having the trailer ID “ID0001” and checked out by “7. CHECK-OUT” from each of the ID database DB1, the moving line database DB2, the pairing database DB3, and the expected value database DB4. Thus, the trailer tracking apparatus 20 can prevent an increase in a storage capacity of various databases by deleting various data corresponding to the trailer that exits outside the yard YRD.

On the other hand, as shown in FIG. 11, for example, it is assumed that a detection error of the trailer occurs and a moving line generated until the detection error occurs is cut off at the time of “3. MOVING TO PARKING LOT” (in other words, the moving line generated until the detection error occurs is determined as a different moving line). As the cause of the moving line being cut off, for example, it is considered that the trailer tracking apparatus 20 erroneously detects that the trailer is different due to the fact that an obstacle (for example, an object of a tree or the like flying by a tornado or a collision) is reflected in the captured image of the trailer tracking camera or image quality is temporarily degraded. It is needless to say that the cause of the moving line being cut off is not limited to the reason described above. In this case, the trailer tracking apparatus 20 assigns, to the trailer, a trailer ID “UN0001” different from the trailer ID “ID0001” detected at the time stamp “0:00”. The trailer ID “UN0001” is, for example, a trailer ID that is temporarily assigned when a trailer that is detected immediately before is not suddenly detected and is treated as identification information of a floating moving line that is not specified as identification information of another trailer. The trailer tracking apparatus 20 adds and writes the time stamp “0:02” indicating a time at which the trailer ID “UN0001” is detected and the trailer ID “UN0001” to the ID database DB1 at the time of “2. CHECK-IN”. The trailer tracking apparatus 20 newly assigns a moving line ID “B” different from the existing moving line ID “A” to the trailer having the trailer ID “UN0001” detected at the time stamp “0:02”. That is, the trailer tracking apparatus 20 detects the position (for example, the coordinates (15, 37)) of the trailer based on the captured image captured by the trailer tracking camera (see FIG. 5), and adds and writes the time stamp “0:02” indicating the time at which the position of the trailer is detected, the position (for example, the coordinates (15, 37)) of the trailer, and the moving line ID “B” indicating that the moving line of the trailer is a new moving line to the moving line database DB2 in association with one another at the time of “2. CHECK-IN”. The trailer tracking apparatus 20 adds and writes the time stamp “0:02”, the trailer ID “UN0001”, the moving line ID “B”, and the trailer position (for example, the coordinates (15, 37)) in the pairing database DB3 at the time of “2. CHECK-IN” as the result of the pairing processing using the data having the time stamp “0:02” common to the ID database DB1 and the moving line database DB2. The contents input at the time of “2. CHECK-IN” are not changed to the expected value database DB4.

Thereinafter, as shown in the ID database DB1 and a second row to a fifth row of the moving line database DB2 and the pairing database DB3 in FIG. 11, it is assumed that the trailer (moving line ID “B”) detected during the event “3. MOVING TO PARKING LOT” continues to be normally detected until “6. 2nd PARKING”.

As shown in FIG. 11, at the time of “7. CHECK-OUT”, the trailer tracking apparatus 20 detects, based on the captured image captured by the trailer tracking camera (see FIG. 5), the position (for example, the coordinates (13, 50)) of the trailer detected at the time of the event of “3. MOVING TO PARKING LOT”, and adds and writes the time stamp “2:00” indicating the time at which the position of the trailer is detected, the position (for example, the coordinates (13, 50)) of the trailer, and the moving line ID “B” indicating that the moving line of the trailer is an existing moving line to the moving line database DB2 in association with one another at the time of “6. 2nd PARKING”. The trailer tracking apparatus 20 adds and writes the time stamp “2:00”, the trailer ID “UN0001”, the moving line ID “B”, and the trailer position (for example, the coordinates (13, 50)) corresponding to the same trailer in the pairing database DB3 at the time of “6. 2nd PARKING” as the result of the pairing processing using the data having the time stamp “2:00” common to the ID database DB1 and the moving line database DB2.

In “8. ARCHIVE AND DELETE DATA OF ID” in FIG. 11, the trailer tracking apparatus 20 deletes various data corresponding to the trailer having the trailer ID “ID0001” detected at the time of the event of “3. MOVING TO PARKING LOT” from each of the ID database DB1, the moving line database DB2, the pairing database DB3, and the expected value database DB4. Various data D1 and D2 corresponding to the trailer ID “UN0001” of the moving line ID “B” is remained as data of the floating moving line. However, the trailer tracking apparatus 20 (for example, the pairing processing unit 25 or the visualization application processing unit 26) executes collation determination as to whether the data of the floating moving line that matches the trailer parking position (PPOS) and the trailer dock position (DPOS) of the expected value database DB4 exists. As shown in FIG. 11, the trailer parking position (PPOS) “5, 31” of the expected value database DB4 matches the trailer position (POS) “5, 31” of the floating moving line, and the trailer dock position (DPOS) “30, 30” of the expected value database DB4 matches the trailer position (POS) “30, 30” of the floating moving line. Therefore, the trailer tracking apparatus 20 determines that the moving line of the moving line ID “B” is the moving line of the trailer ID “ID0001” and archives the various data D1 and D2 corresponding to trailer ID “UN0001” of the moving line ID “B” as the data corresponding to the trailer of the moving line ID “ID0001”. The trailer tracking apparatus 20 may execute the collation determination with respect to the expected value database DB4 during the pairing processing.

FIG. 11 shows an example in which the detection error of the trailer occurs and the moving line generated until the detection error occurs is cut off at the time of “3. MOVING TO PARKING LOT”. The trailer checked in the yard YRD moves along a predetermined path, that is, in an order of check-in, 1st parking, dock-in, 2nd parking, and check-out.

Therefore, when the moving line is cut off while the trailer having the trailer ID “ID0001” is moving along the predetermined path, the trailer tracking apparatus 20 can estimate an approximate position of the trailer having the trailer ID “ID0001” and display the estimated approximate position on at least one of the operator browser apparatus 31 and the yard jockey browser apparatus 32. For example, in a case where the moving line of the trailer is cut off between the check-in and the 1st parking, the trailer tracking apparatus 20 can estimate that the trailer is completed to the check-in and can display that “the trailer is completed to check-in” on at least one of the operator browser apparatus 31 and the yard jockey browser apparatus 32. In a case where the moving line of the trailer is cut off between the 1st parking and the dock-in, the trailer tracking apparatus 20 can estimate that the trailer completes the movement to the 1st parking and can display that “the trailer is completed to 1st parking” on at least one of the operator browser apparatus 31 and the yard jockey browser apparatus 32. In a case where the moving line of the trailer is cut off between the dock-in and the 2nd parking, the trailer tracking apparatus 20 can estimate that the trailer completes the movement to the dock and can display that “the trailer is completed to dock-in” on at least one of the operator browser apparatus 31 and the yard jockey browser apparatus 32. In a case where the moving line of the trailer is cut off between the 2nd parking and the check-out, the trailer tracking apparatus 20 can estimate that the trailer completes the movement to the 2nd parking and can display that “the trailer is completed to 2nd parking” on at least one of the operator browser apparatus 31 and the yard jockey browser apparatus 32. In this way, since the trailer moves along the predetermined path, even when the moving line of the trailer is cut off in the middle, the trailer tracking apparatus 20 can estimate a location where the trailer passes and can display the estimated location on the displayer 30 including the operator browser apparatus 31 or the yard jockey browser apparatus 32. As a result, even when the moving line is cut off during the movement of the trailer along the predetermined path, since the location where the trailer passes can be estimated and displayed on the displayer 30, the trailer tracking apparatus 20 can narrow the position of the trailer having the trailer ID “ID0001” in a wide yard YRD.

### 5. Visualization Example of Position and Moving Line of Trailer

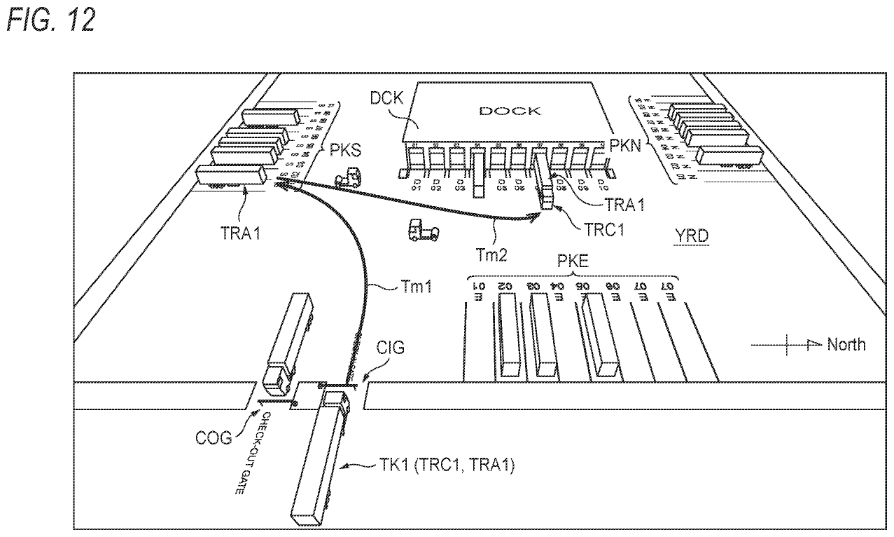

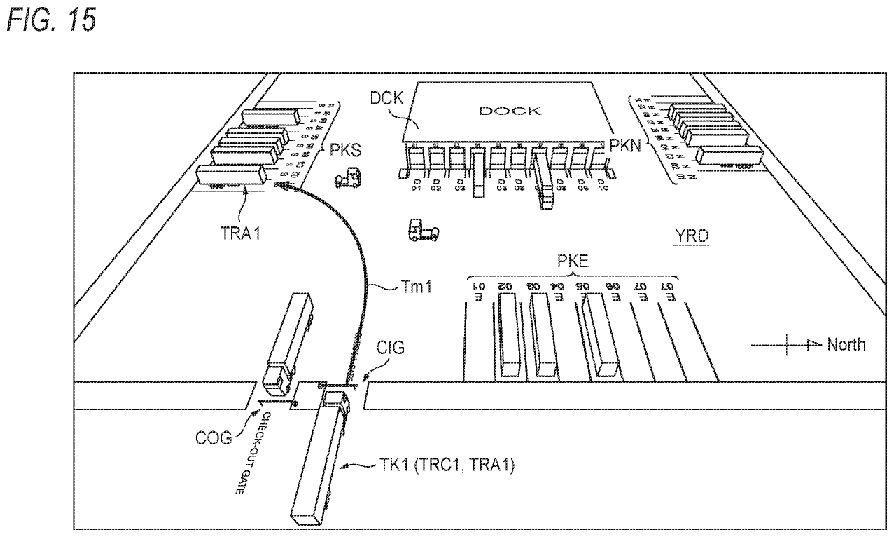

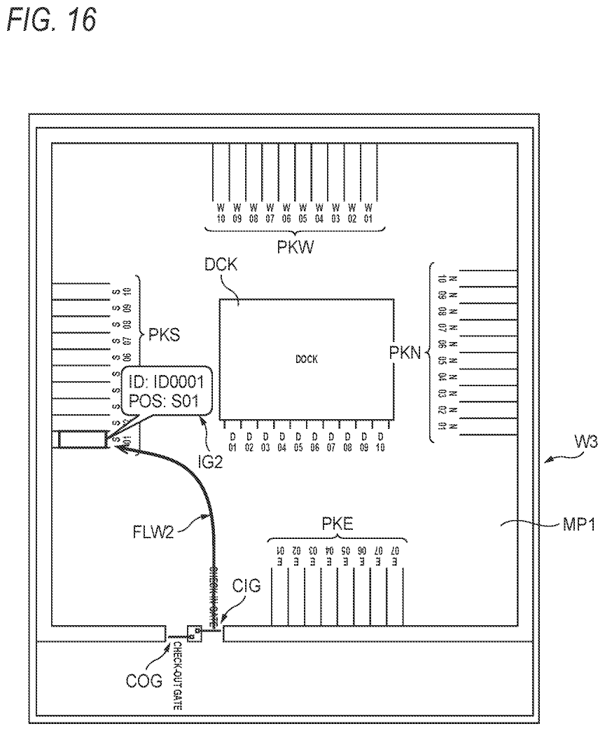

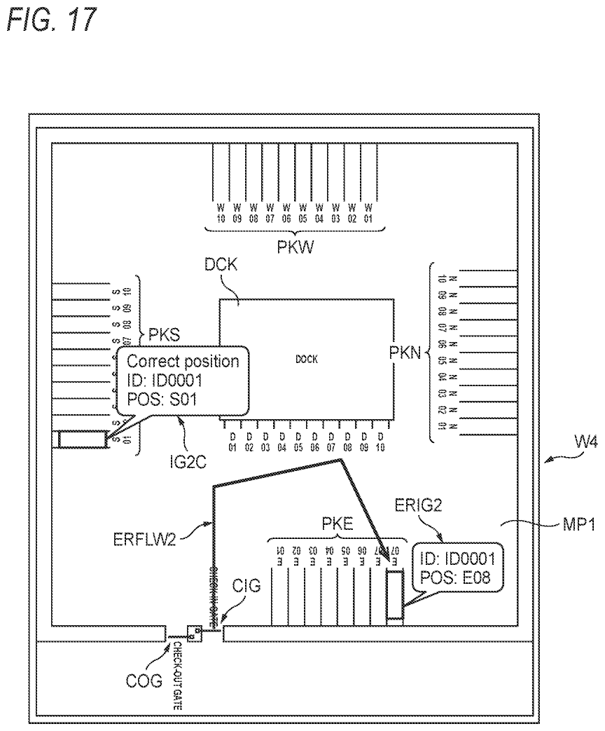

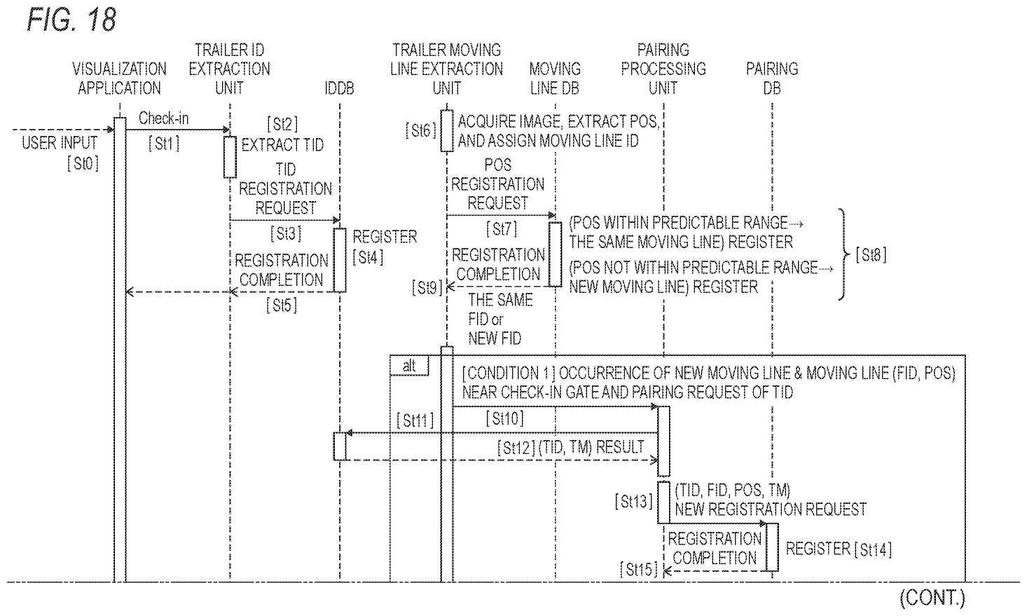

Next, visualization of the position and the moving line in the yard YRD of the trailer TRA1 tracked by the trailer tracking system 100 according to the present embodiment will be described with reference to FIGS. 12 to 17. FIG. 12 is a diagram schematically showing a first moving line example of the trailer TRA1 checked in the yard YRD. FIG. 13 is a diagram showing an example of a mapping display screen for visualizing that the trailer TRA1 of FIG. 12 is parked at a correct position as instructed, displayed on the displayer 30. FIG. 14 is a diagram showing an example of a mapping display screen for visualizing that the trailer TRA1 of FIG. 12 is parked at an incorrect position different from the instruction, displayed on the displayer 30. FIG. 15 is a diagram schematically showing a second moving line example of the trailer TRA1 checked in the yard YRD. FIG. 16 is a diagram showing an example of a mapping display screen for visualizing that the trailer TRA1 of FIG. 15 is parked at a correct position as instructed, displayed on the displayer 30. FIG. 17 is a diagram showing an example of a mapping display screen for visualizing that the trailer TRA1 of FIG. 15 is parked at an incorrect position different from the instruction, displayed on the displayer 30.

In the description of FIGS. 12 to 17, the same elements as those in FIGS. 1, 2, and 5 are denoted by the same reference numerals, the description thereof is simplified or omitted, and different contents will be described.

### (1) Visualization Example of First Moving Line: See FIGS. 12, 13, and 14

As shown in FIG. 12, when passing through the check-in gate CIG of the yard YRD, a tractor TRC (that is, the transportation truck TK1) towing a trailer TRA moves toward a designated parking space of the parking space PKS along a movement path Tm1. After a certain period of time after the movement is elapsed, the tractor TRC (that is, the transportation truck TK1) towing the trailer TRA moves from the parking space toward the dock DCK along a movement path Tm2. Such movement paths Tm1 and Tm2 are assumed.

When receiving the visualization request from the displayer 30, the visualization application processing unit 26 of the trailer tracking apparatus 20 generates a mapping display screen W1 (see FIG. 13) and a mapping display screen W2 (see FIG. 14) including a current position of the trailer TRA1 designated by the visualization request up to a time (in other words, the current time) at which the visualization request is received and a moving line FLW1 from the check-in of the yard YRD to the current position.

First, a case will be considered in which the driver or the yard jockey who drives the tractor TRC1 towing the trailer TRA1 passes through the check-in gate CIG, moves to the designated parking space of the parking space PKS, and further appropriately moves to a designated parking position of the dock DCK from the parking space (see FIG. 13). That is, a visualization example of the moving line when the trailer TRA1 moves as instructed by the operator will be considered.

In this case, the visualization application processing unit 26 extracts positions of the trailer TRA1 obtained by being continuously detected during the movement from the check-in gate CIG to the designated parking space of the parking space PKS and the movement from the parking space to the designated parking position of the dock DCK by referring to the pairing database DB3. Furthermore, the visualization application processing unit 26 generates the moving line FLW1 by connecting the extracted positions with straight lines or the like. The visualization application processing unit 26 generates the mapping display screen W1 in which an indicator IG1 indicating an extracted position (current position) of the trailer TRA1 and the moving line FLW1 are superimposed and drawn on an overhead map MP1 of the yard YRD and outputs (transmits) the mapping display screen W1 to the displayer 30, which is the transmission source of the visualization request, at least. Data of the map MP1 is stored in the memory 21 in advance. The indicator IG1 notifies, for example, the trailer ID of the trailer TRA1, which is the target of the visualization request, and information indicating the current position (for example, information indicating “D07” which is a seventh parking space of the dock DCK) in association with each other.

On the other hand, a case will be considered in which the driver or the yard jockey who drives the tractor TRC1 towing the trailer TRA1 passes through the check-in gate CIG, appropriately moves to the designated parking space of the parking space PKS but moves to a parking position different from the designated parking position of the dock DCK from the parking space (see FIG. 14). That is, a visualization example of the moving line when the trailer TRA1 cannot move as instructed by the operator will be considered.

In this case, the visualization application processing unit 26 extracts positions of the trailer TRA1 obtained by being continuously detected during the movement from the check-in gate CIG to the designated parking space of the parking space PKS and the movement from the parking space to the designated parking position of the dock DCK by referring to the pairing database DB3. Furthermore, the visualization application processing unit 26 generates an inappropriate moving line ERFLW1 by connecting the extracted positions with straight lines or the like. The visualization application processing unit 26 generates the mapping display screen W2 in which an indicator ERIG1 indicating an extracted inappropriate position (current position) of the trailer TRA1 and the moving line ERFLW1 are superimposed and drawn on the overhead map MP1 of the yard YRD and outputs (transmits) the mapping display screen W2 to the displayer 30, which is the transmission source of the visualization request, at least. In addition, the visualization application processing unit 26 may generate and output (transmit) the mapping display screen W2 in which an indicator IG1C indicating the current position as an appropriate movement destination defined in the expected value database DB4 is added and superimposed and drawn on the map MP1. The indicator ERIG1 notifies, for example, the trailer ID of the trailer TRA1, which is the target of the visualization request, and information (for example, information indicating “D04”, which is a fourth parking space of the dock DCK) indicating an inappropriate current position at which the trailer TRA1 is positioned by erroneous movement. The indicator IG1C notifies, for example, the trailer ID of the trailer TRA1, which is the target of the visualization request, and information (for example, the information indicating “D07”, which is the seventh parking space of the dock DCK) indicating the current position at which the trailer TRA1 is to be positioned at the time of reception of the visualization request in association with each other.

### (2) Visualization Example of Second Moving Line: See FIGS. 15, 16, and 17

As shown in FIG. 15, when passing through the check-in gate CIG of the yard YRD, the tractor TRC (that is, the transportation truck TK1) towing the trailer TRA moves toward the designated parking space of the parking space PKS along the movement path Tm1. Such a movement path Tm1 is assumed.

When receiving the visualization request from the displayer 30, the visualization application processing unit 26 of the trailer tracking apparatus 20 generates the mapping display screen W1 (see FIG. 16) and the mapping display screen W2 (see FIG. 17) including the current position of the trailer TRA1 designated by the visualization request up to the time (in other words, the current time) at which the visualization request is received and a moving line FLW2 from the check-in of the yard YRD to the current position.

First, a case will be considered in which the driver or the yard jockey who drives the tractor TRC1 towing the trailer TRA1 passes through the check-in gate CIG and appropriately moves to the designated parking space of the parking space PKS (see FIG. 16). That is, a visualization example of the moving line when the trailer TRA1 moves as instructed by the operator will be considered.

In this case, the visualization application processing unit 26 extracts positions of the trailer TRA1 obtained by being continuously detected during the movement from the check-in gate CIG to the designated parking space of the parking space PKS by referring to the pairing database DB3. Furthermore, the visualization application processing unit 26 generates the moving line FLW2 by connecting the extracted positions with straight lines or the like. The visualization application processing unit 26 generates a mapping display screen W3 in which an indicator IG2 indicating an extracted position (current position) of the trailer TRA1 and the moving line FLW2 are superimposed and drawn on the overhead map MP1 of the yard YRD and outputs (transmits) the mapping display screen W3 to the displayer 30, which is the transmission source of the visualization request, at least. The indicator IG2 notifies, for example, the trailer ID of the trailer TRA1, which is the target of the visualization request, and information indicating the current position (for example, information indicating “S01” which is a first parking space of the parking space PKS) in association with each other.

On the other hand, a case will be considered in which the driver or the yard jockey who drives the tractor TRC1 towing the trailer TRA1 passes through the check-in gate CIG and moves to the parking space PKE different from the designated parking space PKS (see FIG. 17). That is, a visualization example of the moving line when the trailer TRA1 cannot move as instructed by the operator will be considered.

In this case, the visualization application processing unit 26 extracts positions of the trailer TRA1 obtained by being continuously detected during the movement from the check-in gate CIG to a parking space of the parking space PKE by referring to the pairing database DB3. Furthermore, the visualization application processing unit 26 generates an inappropriate moving line ERFLW2 by connecting the extracted positions with straight lines or the like. The visualization application processing unit 26 generates a mapping display screen W4 in which an indicator ERIG2 indicating an extracted inappropriate position (current position) of the trailer TRA1 and a moving line ERFLW2 are superimposed and drawn on the overhead map MP1 of the yard YRD and outputs (transmits) the mapping display screen W4 to the displayer 30, which is the transmission source of the visualization request, at least. In addition, the visualization application processing unit 26 may generate and output (transmit) the mapping display screen W4 in which an indicator IG2C indicating the current position as an appropriate movement destination defined in the expected value database DB4 is added and superimposed and drawn on the map MP1. The indicator ERIG2 notifies, for example, the trailer ID of the trailer TRA1, which is the target of the visualization request, and information (for example, information indicating “E08”, which is an eighth parking space of the parking space PKE) indicating an inappropriate current position at which the trailer TRA1 is positioned by erroneous movement. The indicator IG2C notifies, for example, the trailer ID of the trailer TRA1, which is the target of the visualization request, and information (for example, the information indicating “S01”, which is the first parking space of the parking space PKS) indicating the current position at which the trailer TRA1 is to be positioned at the time of receiving the visualization request in association with each other.

### 6. Operation Procedure of Trailer Tracking System

Next, an operation procedure of the trailer tracking system 100 according to the present embodiment will be described with reference to FIGS. 18 and 19. FIG. 18 is a sequence diagram showing, in time series, an operation procedure from the check-in of the trailer to the pairing processing of trailer information in the trailer tracking system 100 according to the present embodiment. FIG. 19 is a sequence diagram showing, in time series, an operation procedure of visualizing a position and a moving line of the trailer of the trailer tracking system 100 according to the present embodiment.

As a premise for the description of FIG. 18, data of the captured image may be periodically input to the trailer tracking apparatus 20 according to a frame from at least each of the trailer tracking cameras C1 to C8, and further data of the captured image may be periodically input to the trailer tracking apparatus 20 according to a frame rate from each of the trailer ID reading cameras IC1 and IC2. In the description of FIG. 18 or FIG. 19, the visualization application processing unit is abbreviated as a “visualization application”, the database is abbreviated as a “DB”, and at least one of the operator browser apparatus and the yard jockey browser apparatus is abbreviated as a “browser apparatus”.

In FIG. 18, the visualization application processing unit 26 of the trailer tracking apparatus 20 acquires an instruction of detection processing of check-in of a transportation truck (for example, a trailer) about to enter the yard YRD (step St1) by an operation input by a user (for example, the operator) using the browser apparatus (step St0). The visualization application processing unit 26 instructs the trailer ID extraction unit 23 to execute trailer ID detection processing. The trailer ID extraction unit 23 uses the captured image (see FIG. 4) of the trailer ID reading camera IC1 to detect and extract the identification information IDct1 (TID: trailer ID) of the trailer shown on the captured image based on the instruction from the visualization application processing unit 26 (step St2). In step St2, the trailer ID extraction unit 23 may extract the identification information IDct1 (TID: trailer ID) of the trailer based on the operation input of the user (for example, the operator) who uses the browser apparatus instead of the captured image (see FIG. 4) of the trailer ID reading camera IC1.

The trailer ID extraction unit 23 sends to the ID database DB1 a TID registration request for registering the trailer ID extracted in step St2 and a time stamp indicating a detected time in the ID database DB1 in association with each other (step St3). The ID database DB1 registers the trailer ID extracted in step St2 and the time stamp indicating the time at which the trailer ID is detected in association with each other in accordance with the TID registration request from the trailer ID extraction unit 23 (step St4) and returns a registration completion response (Ack: Acknowledgment) to the visualization application processing unit 26 (step St5).

The trailer moving line extraction unit 24 acquires the data of the captured image from each of the trailer tracking cameras C1 to C8 while the trailer tracking apparatus 20 is in operation (step St6), detects the positions (POS) of the trailer shown in the captured images, and extracts the position information using these captured images (step St6). At this time, the trailer moving line extraction unit 24 determines whether the position indicated by the extracted position information forms the same moving line or a different moving line with a position indicated by the position information extracted most recently (last time) based on a predetermined determination criterion (see above). That is, when determining that the position indicated by the extracted position information is within a predictable range (see above) from the position indicated by the position information extracted most recently (last time), the trailer moving line extraction unit 24 assigns the same moving line ID as the moving line ID of the existing moving line. On the other hand, when determining that the position indicated by the extracted position information is not within the predictable range (see above) from the position indicated by the position information extracted most recently (last time), the trailer moving line extraction unit 24 assigns a new moving line ID.

The trailer moving line extraction unit 24 sends to the moving line database DB2 a POS registration request for registering the position information of the trailer extracted in step St6, the assigned moving line ID, and a time stamp indicating a time at which the position is detected in association with one another in the moving line database DB2 (step St7). The moving line database DB2 registers the position information of the trailer extracted in step St6, the assigned moving line ID, and the time stamp indicating the detected time in association with one another in accordance with the POS registration request from the trailer moving line extraction unit 24 (step St8) and returns a registration completion response (Ack) to the visualization application processing unit 26 (step St9).

Here, the trailer moving line extraction unit 24 instructs the pairing processing unit 25 to determine whether the predetermined conditions (for example, [Condition 1], [Condition 2], and [Condition 3], see FIG. 18) are satisfied (step St10, St16, and St20).

In step St10, the trailer moving line extraction unit 24 sends to the pairing processing unit 25 the position information of the trailer extracted in step St6, the assigned moving line ID, and the time stamp indicating the time at which the position is detected in association with one another (step St10).

The pairing processing unit 25 accesses the data of the extraction result of the trailer ID from the trailer ID extraction unit 23 to the trailer ID extraction unit 23 or the ID database DB1 (step St11) and acquires the data (step St12). Here, as [Condition 1], the pairing processing unit 25 determines whether a new moving line ID (FID) is assigned in step St6 and the position (POS) and the moving line of the trailer near the check-in gate CIG and the ID (TID) of the trailer are acquired. That is, [Condition 1] defines that various data such as the time stamp, the position, and the moving line of the trailer are stored in advance as initial data in association with one another when the trailer is detected for the first time at the check-in gate CIG.

The pairing processing unit 25 determines that [Condition 1] is satisfied (that is, the new moving line ID (FID) is assigned in step St6 and the position (POS) and the moving line of the trailer near the check-in gate CIG and the ID (TID) of the trailer are acquired). In this case, the pairing processing unit 25 sends to the pairing database DB3 a new registration request for registering a time stamp (TM) indicating a time at which the trailer is detected near the check-in gate CIG, the position (POS) of the trailer, the moving line ID (FID) indicating the moving line of the trailer, and the ID (TID) of the trailer to the pairing database DB3 in association with one another (step St13). The pairing database DB3 registers the time stamp (TM) indicating the time at which the trailer is detected near the check-in gate CIG, the position (POS) of the trailer, the moving line ID (FID) indicating the moving line of the trailer, and the ID (TID) of the trailer in association with one another in accordance with the new registration request from the pairing processing unit 25 (step St14) and returns a registration completion response (Ack) to the pairing processing unit 25 (step St15).

In step St16, the trailer moving line extraction unit 24 sends to the pairing processing unit 25 the position information of the trailer extracted in step St6, the assigned moving line ID, and the time stamp indicating the time at which the position is detected in association with one another (step St16).

As [Condition 2], the pairing processing unit 25 determines whether the new moving line ID (FID) is assigned in step St6 and the position (POS) and the moving line of the trailer in a location in the yard YRD other than the check-in gate CIG and the ID (TID) of the trailer are acquired.

That is, [Condition 2] defines that when a trailer once detected at the check-in gate CIG is erroneously detected as another trailer while moving in the yard YRD, various data such as the moving line, the position, the time stamp of the erroneously detected trailer are temporarily stored in advance as data of a floating moving line.

The pairing processing unit 25 determines that [Condition 2] is satisfied (that is, the new moving line ID (FID) is assigned in step St6 and the position (POS) and the moving line of the trailer in the location in the yard YRD other than the check-in gate CIG and the ID (TID) of the trailer are acquired). In this case, the pairing processing unit 25 sends to the pairing database DB3 a new registration request for registering a time stamp (TM) indicating a time at which the trailer is detected at the location in the yard YRD other than the check-in gate CIG, the position (POS) of the trailer, the moving line ID (FID: that is, the newly assigned moving line ID) indicating the moving line of the trailer, and the ID (TID) of the trailer to the pairing database DB3 in association with one another (step St17). The pairing database DB3 registers the time stamp (TM) indicating the time at which the trailer is detected at the location in the yard YRD other than the check-in gate CIG, the position (POS) of the trailer, the moving line ID (FID: that is, the newly assigned moving line ID) indicating the moving line of the trailer, and the ID (TID) of the trailer in association with one another in accordance with the new registration request from the pairing processing unit 25 (step St18) and returns a registration completion response (Ack) to the pairing processing unit 25 (step St19).

In step St20, the trailer moving line extraction unit 24 sends to the pairing processing unit 25 the position information of the trailer extracted in step St6, the assigned moving line ID, and the time stamp indicating the time at which the position is detected in association with one another (step St20).

As [Condition 3], the pairing processing unit 25 determines whether an existing moving line ID (FID) is assigned in step St6 (in other words, the trailer ID corresponding to the moving line ID is already detected).

That is, [Condition 3] defines that when the trailer that passes through the check-in gate CIG and is already moving in the yard YRD is normally detected in the yard YRD, various data such as the time stamp, the position, and the moving line of the trailer in the yard YRD is stored in advance in association with one another.

The pairing processing unit 25 determines that [Condition 3] is satisfied (that is, the existing moving line ID (FID) is assigned in step St6 (in other words, the trailer ID corresponding to the moving line ID is already detected)). In this case, the pairing processing unit 25 sends to the pairing database DB3 an additional registration request for registering a time stamp (TM) indicating a time at which the trailer is detected at the location in the yard YRD other than the check-in gate CIG, the position (POS) of the trailer, the moving line ID (FID: that is, an already assigned moving line ID) indicating the moving line of the trailer, and the ID (TID) of the trailer to the pairing database DB3 in association with one another (step St21). The pairing database DB3 registers the time stamp (TM) indicating the time at which the trailer is detected at the location in the yard YRD other than the check-in gate CIG, the position (POS) of the trailer, the moving line ID (FID: that is, the already assigned moving line ID) indicating the moving line of the trailer, and the ID (TID) of the trailer in association with one another in accordance with the additional registration request from the pairing processing unit 25 (step St22) and returns a registration completion response (Ack) to the pairing processing unit 25 (step St23).

In addition, the visualization application processing unit 26 of the trailer tracking apparatus 20 acquires an instruction of detection processing of check-out of the transportation truck (for example, the trailer) about to exit outside the yard YRD (step St25) by an operation input by the user (for example, the operator) using the browser apparatus (step St24). The visualization application processing unit 26 instructs the trailer ID extraction unit 23 to execute deletion processing of a trailer ID of a trailer which is not managed so as to exit outside the yard YRD. The trailer ID extraction unit 23 sends to the ID database DB1 an ID deletion request for deleting a corresponding trailer ID and a time stamp indicating a time at which the trailer ID is detected from the ID database DB1, based on the instruction from the visualization application processing unit 26 (step St26). The ID database DB1 deletes the trailer ID extracted in step St2 and the time stamp indicating the time at which the trailer ID is detected in accordance with the ID deletion request from the trailer ID extraction unit 23 (step St27) and returns a deletion completion response (Ack) to the visualization application processing unit 26 (step St28).

In FIG. 19, the browser apparatus (displayer 30) generates a visualization request (parking map display) for requesting the position of the current trailer and the visualization of the moving line based on the operation input of the user (for example, the yard jockey) (step St31) and sends the visualization request to the trailer tracking apparatus 20 (step St32). The visualization request (parking map display) is, for example, a command for requesting that the yard jockey moves the trailer to a designated position of the trailer but cannot find the position and visualizes the parking map in the site of the yard YRD (that is, the position on the map of the parking space in which the trailer is parked). The visualization request (parking map display) includes at least the trailer ID of the target trailer.

When receiving the visualization request of step St32, the visualization application processing unit 26 of the trailer tracking apparatus 20 generates an information acquisition request related to the current position (for example, the parking position) of the trailer corresponding to the trailer ID included in the visualization instruction (parking map display) and sends the information acquisition request to the pairing processing unit 25 or the pairing database DB3 (step St33). The pairing processing unit 25 or the pairing database DB3 acquires corresponding various data (for example, the trailer ID, the time stamp indicating the current time, the position information of the trailer at the current time, and the moving line ID) from the pairing database DB3 in accordance with the information acquisition request of step St33 (step St34). The current time may be a time at which the visualization request is generated by the browser apparatus and may be a time at which the visualization request is received in the trailer tracking apparatus 20, and the same in the following.

The pairing processing unit 25 or the pairing database DB3 returns various data (see above) acquired at step St34 to the visualization application processing unit 26 (step St35). The visualization application processing unit 26 generates (draws) a mapping display screen (see, for example, the mapping display screen W1 of FIG. 13 or the mapping display screen W3 of FIG. 16) using the various data (see above) obtained in step St35 (step St36). The visualization application processing unit 26 transmits and outputs the mapping display screen generated in step St36 to the browser apparatus (step St37).

On the other hand, the browser apparatus (displayer 30) generates a visualization request (illegal parking position display) for requesting visualization of whether the trailer is parked illegally (in other words, erroneously) at the current time based on an operation input of the user (for example, the operator) (step St41A) and sends the visualization request to the trailer tracking apparatus 20 (step St42A). The visualization request (illegal parking position display) is. For example, a command for visualizing the parking map (that is, a position on the map of the parking space where the trailer is illegally parked) in the site of the yard YRD when the operator periodically monitors whether a trailer that is illegally parked in the yard YRD is present. The visualization request (illegal parking position display) includes at least the trailer ID of the target trailer.

When it is determined that [Condition 2] is satisfied (see step St16 in FIG. 18) (step St41B), the trailer moving line extraction unit 24 may generate the visualization request (illegal parking position display) described above and send the visualization request to the visualization application processing unit 26 (step St42B).

When receiving the visualization request (illegal parking position display), the visualization application processing unit 26 generates a parking position information acquisition request for acquiring various data about the trailer corresponding to the trailer ID included in the visualization request (parking map display) and sends the parking position information acquisition request to the pairing processing unit 25 or the pairing database DB3 (step St43). The pairing processing unit 25 or the pairing database DB3 acquires corresponding various data (for example, the trailer ID, the time stamp indicating the current time, the position information of the trailer at the current time, and the moving line ID) from the pairing database DB3 in accordance with the parking position information acquisition request of step St43 (step St44). The pairing processing unit 25 or the pairing database DB3 returns various data (see above) acquired at step St44 to the visualization application processing unit 26 (step St45).

In addition, the visualization application processing unit 26 generates the parking position information acquisition request for acquiring various data about the trailer corresponding to the trailer ID included in the visualization request (parking map display) and sends the parking position information acquisition request to the expected value database DB4 (step St46). The expected value database DB4 acquires corresponding various data (for example, the trailer ID, the time stamp indicating the current time, parking position information of the trailer to be positioned at the current time, and a trailer dock position to be positioned at the current time) from the expected value database DB4 in accordance with the parking position information acquisition request of step St46 (step St47). The expected value database DB4 returns various data (see above) acquired at step St47 to the visualization application processing unit 26 (step St48).

The visualization application processing unit 26 executes collation processing as to whether various data acquired at step St45 from the pairing database DB3 matches various data acquired at step St48 from the expected value database DB4 (step St49). The visualization application processing unit 26 generates (draws) a mapping display screen (see, for example, the mapping display screen W2 of FIG. 14 or the mapping display screen W4 of FIG. 17) indicating a result of the collation processing of step St49 (step St50). The visualization application processing unit 26 transmits and outputs the mapping display screen generated in step St50 to the browser apparatus (step St51).

As described above, the trailer tracking apparatus 20 according to the present embodiment includes an acquisition unit (communication interface 22) that acquires, from at least one camera (the trailer ID reading camera IC1 and the trailer tracking cameras C1 to C8) that captures the image of the predetermined movement path of the trailer (trailer TRA1) in the yard YRD having a wide site, the captured image of the camera, a database (pairing database DB3) that stores identification information (trailer ID) on the trailer and information on the position of the trailer in the yard YRD based on the captured image of the camera in association with each other, and a visualization processing unit (visualization application processing unit 26) that outputs information on a current position of the trailer specified by the visualization instruction from an external browser apparatus (displayer 30) to the external browser apparatus based on the database. As a result, since the trailer tracking apparatus 20 can appropriately manage the position information of the trailer in the yard YRD, the worker (yard jockey) can easily visualize the position of the target trailer (for example, the trailer that needs to be towed), and finding the target trailer of the yard jockey can be efficiently assisted.

The trailer tracking apparatus 20 further includes the pairing processing unit 25 which associates the identification information (trailer ID) on the trailer with the information on the position of the trailer in the yard YRD based on the image captured by the camera. Thus, even when a device (for example, the trailer ID reading camera IC1) that is an acquisition source of the trailer ID is different from a device (for example, the trailer tracking cameras C1 to C8) that is an acquisition source of the position information in the yard YRD of the trailer, the trailer tracking apparatus 20 can appropriately associate and manage the trailer information.

The camera includes a first camera (trailer ID reading camera IC1) provided at the entrance (check-in gate CIG) of the yard YRD and reading the identification information (trailer ID) on the trailer. The trailer tracking apparatus 20 further includes the trailer ID extraction unit 23 which extracts the identification information (trailer ID) on the trailer based on a captured image of the first camera. Accordingly, the trailer tracking apparatus 20 can appropriately detect and extract the trailer ID of the trailer about to enter the yard YRD based on the captured image of the trailer ID reading camera IC1.

The camera includes at least one second camera (the trailer tracking cameras C1 to C8) provided in the yard YRD and capturing an image of the predetermined movement path of the trailer (trailer TRA1) in the yard YRD having a wide site. The trailer tracking apparatus 20 further includes the trailer moving line extraction unit 24 that extracts a moving line of the trailer, which is determined by the estimated position of the trailer for each time in the yard YRD, in addition to estimating the position of the trailer in the yard YRD based on the captured image of the second camera. Thus, the trailer tracking apparatus 20 can quantify and store (register) the position and the moving line (that is, the movement trajectory) of the trailer in the yard YRD using the captured image of the trailer tracking camera that can capture an image of the movement path along which the trailer in the yard YRD moves.

The trailer moving line extraction unit 24 adds, when it is determined that the first position (the latest detection position) indicating the position of the trailer in the yard YRD based on the captured image of the second camera (trailer tracking cameras C1 to C8) is within a prediction range, a moving line up to the first position to an extracted moving line. The trailer moving line extraction unit 24 adds, when it is determined that the first position indicating the position of the trailer in the yard YRD based on the captured image of the second camera is not within the prediction range, the moving line up to the first position as a new moving line. As a result, the trailer tracking apparatus 20 can manage the moving line of the trailer by connecting the moving line of the trailer to the existing moving line in accordance with whether the position of the trailer which can move in the yard YRD can be predicted and can also manage the new moving line starting from the position of the trailer.

The visualization processing unit (visualization application processing unit 26) outputs to the external browser apparatus (displayer 30) the current position of the trailer specified by the visualization instruction and a moving line indicating a movement trajectory in the yard YRD to the current position in association with each other. Accordingly, the trailer tracking apparatus 20 can visualize and output the current position of the trailer desired to be searched for by the user (for example, the operator or the yard jockey) who uses the displayer 30 and the moving line (movement trajectory) in the yard YRD of the trailer to the displayer 30 in association with each other.

The trailer tracking apparatus 20 further includes a second database (expected value database DB4) that stores information on a position on the movement path for each time in the yard YRD of the trailer. The visualization processing unit (visualization application processing unit 26) outputs to the external browser apparatus (displayer 30) the current position of the trailer specified by the visualization instruction and a position at which the trailer is to be parked at the current time comparatively. Accordingly, the trailer tracking apparatus 20 can visualize whether the current position of the trailer in the yard YRD periodically monitored by the user (for example, the operator) who uses the displayer 30 matches the position where the trailer normally exists, and can provide a determination material of the user.

### Modification of First Embodiment

In a modification of the first embodiment (hereinafter, referred to as a “modification”), a trailer tracking apparatus calculates a trailer detection reliability using a prediction probability indicating whether the trailer per se is appropriately detected and a score indicating a matching rate between a predicted position and an actual detection position of the trailer. The trailer tracking apparatus changes a display mode of a position and a moving line of the trailer in a mapping display screen in accordance with a calculation result of the trailer detection reliability. A configuration of the trailer tracking system according to the modification other than the trailer tracking apparatus is the same as the configuration of the trailer tracking system 100 according to the first embodiment other than the trailer tracking apparatus 20.

### 6. Configuration of Trailer Tracking Apparatus

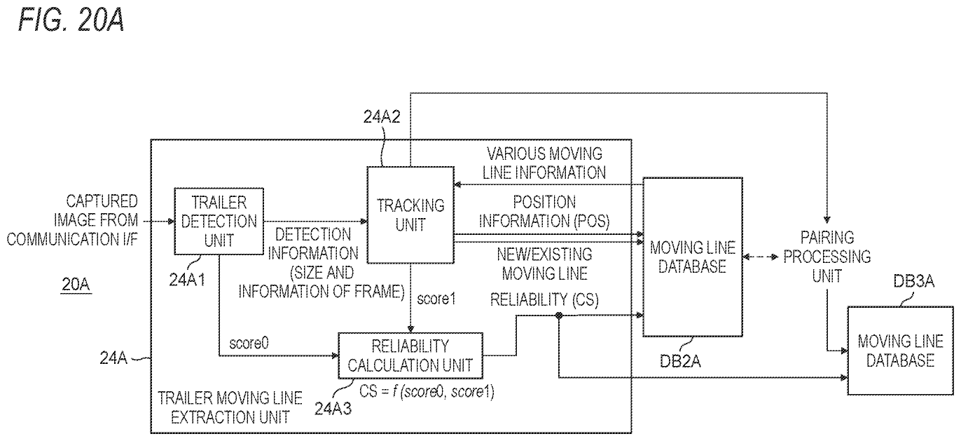

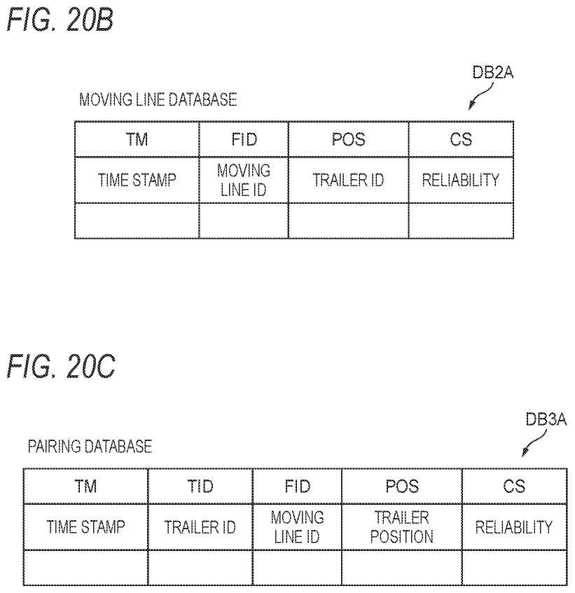

Next, a trailer moving line extraction unit 24A, a moving line database DB2A, and a pairing database DB3A of a trailer tracking apparatus 20A according to the modification will be described with reference to FIGS. 20A, 20B, and 20C. FIG. 20A is a block diagram showing a detailed functional configuration example of the trailer moving line extraction unit 24A according to the modification. FIG. 20B is a diagram showing a configuration example of the moving line database DB2A according to the modification. FIG. 20C is a diagram showing a configuration example of the pairing database DB3A according to the modification. In each description of FIGS. 20A to 20C, configurations the same as the elements of the first embodiment are denoted by the same reference numerals, the description thereof is simplified or omitted, and different contents will be described.

The configuration of the trailer tracking apparatus 20A according to the modification is different from the configuration of the trailer tracking apparatus 20 according to the first embodiment only in the trailer moving line extraction unit 24A, the moving line database DB2A, and the pairing database DB3A, and the other configurations are the same. Therefore, FIG. 20A shows a detailed configuration example of the trailer moving line extraction unit 24A, FIG. 20B shows a detailed configuration example of the moving line database DB2A, and FIG. 20C shows a detailed configuration example of the pairing database DB3.

The trailer moving line extraction unit 24A includes a trailer detection unit 24A1, a tracking unit 24A2, and a reliability calculation unit 24A3.

The trailer detection unit 24A1 periodically acquires data from the communication interface 22 (that is, data of a captured image from each of the trailer tracking cameras C1 to C8). The trailer detection unit 24A1 analyzes the data of the captured image from a trailer tracking camera (for example, the trailer tracking camera C1) to periodically extract position information that indicates the position of the trailer shown in the captured image. The trailer detection unit 24A1 sends detection information (for example, a size and position of a detection frame of the trailer) of the trailer to the tracking unit 24A2. The trailer detection unit 24A1 calculates the prediction probability (score0) indicating a detection accuracy of the trailer per se along with the detection of the trailer and sends the prediction probability to the reliability calculation unit 24A3.

The tracking unit 24A2 refers to various data (moving line information) stored (registered) in the moving line database DB2A, determines whether a position indicating position information included in the detection information from the trailer detection unit 24A1 forms the same moving line or a different moving line with a position indicating position information extracted most recently (last time), and assigns a moving line ID based on a determination result.

The tracking unit 24A2 calculates a score (score1) indicating a matching rate between the predicted position of the trailer based on the position of the trailer detected most recently (last time) and an actual detection position (latest position) and sends the score to the reliability calculation unit 24A3. The tracking unit 24A2 stores (registers) a time stamp, which is a time at which the trailer is detected, a moving line ID (FID) of the trailer, and extracted position information in the moving line database DB2A in association with one another.

The reliability calculation unit 24A3 calculates a trailer detection reliability CS by calculating a predetermined function (f(score0, score1)) to which the prediction probability (score0) from the trailer detection unit 24A1 and the score (score1) from the tracking unit 24A2 are input. The reliability calculation unit 24A3 stores (registers) the trailer detection reliability CS in each of the moving line database DB2A and the pairing database DB3A. The trailer detection reliability is abbreviated as “reliability” in FIGS. 20A to 20C.

The moving line database DB2A is a database that stores (registers) a time stamp (TM) indicating a time at which the position information of the trailer is extracted by the trailer moving line extraction unit 24A, a trailer position (POS) indicated by the extracted position information (for example, two-dimensional coordinates), a moving line ID (FID) indicating whether the trailer position forms a new moving line or an existing moving line, and the trailer detection reliability calculated by the reliability calculation unit 24A3 in association with one another (see FIG. 20B).

As shown in FIG. 20B, the moving line database DB2A stores the time stamp (TM), the moving line ID (FID), the trailer position (POS), and the trailer detection reliability in association with one another.

The pairing database DB3A is a database that stores (registers) the time stamp (TM) indicating the time at which the trailer ID is extracted and the time at which the position information of the trailer is extracted, which are the same time, the extracted trailer ID (TID), the trailer position (POS) indicated by the extracted position information, the moving line ID (FID) indicating whether the trailer position forms any one of the new moving line or the existing moving line, and the trailer detection reliability calculated by the reliability calculation unit 24A3 in association with each other (see FIG. 20C).

As shown in FIG. 20C, the pairing database DB3A stores the time stamp (TM), the trailer ID (TID), the moving line ID (FID), the trailer position (POS), and the trailer detection reliability in association with one another.

### 7. Display Mode of Mapping Display Screen

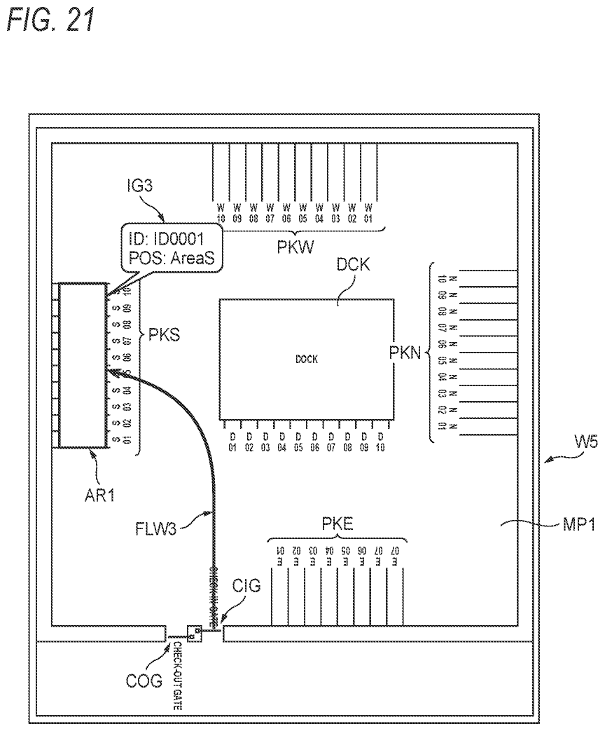

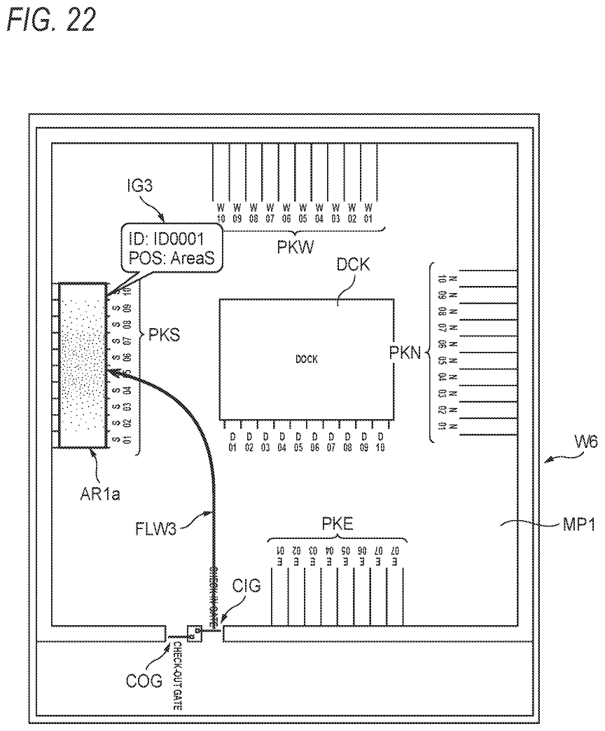

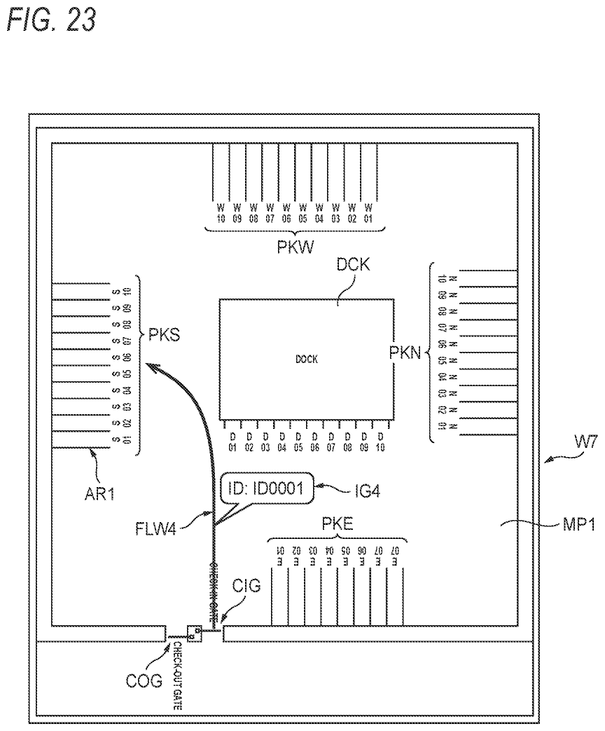

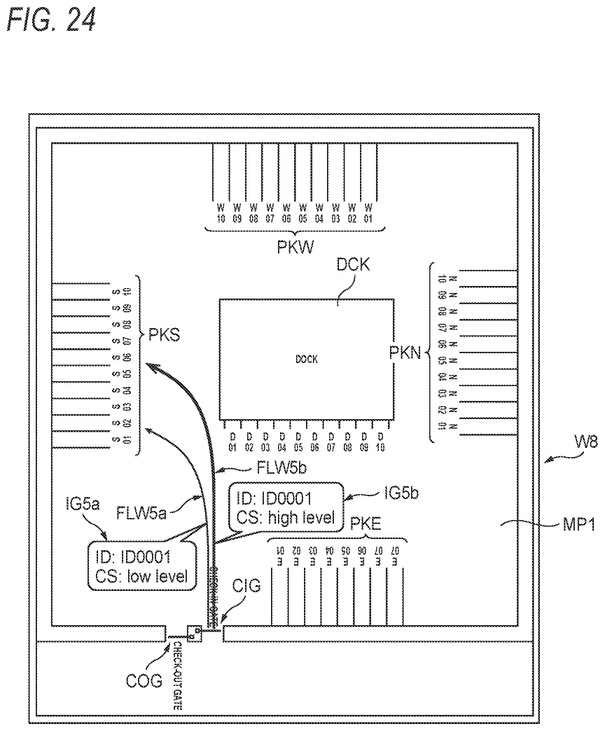

Next, various kinds of display modes of a mapping display screen according to the modification will be described with reference to FIGS. 21 to 24. FIG. 21 is a diagram showing a first visualization example of a position of the trailer checked in the yard YRD, displayed on the displayer 30 according to the modification. FIG. 22 is a diagram showing a second visualization example of a position of the trailer checked in the yard YRD, displayed on the displayer 30 according to the modification. FIG. 23 is a diagram showing a third visualization example of a position of the trailer checked in the yard YRD, displayed on the displayer 30 according to the modification. FIG. 24 is a diagram showing a fourth visualization example of a position of the trailer checked in the yard YRD, displayed on the displayer 30 according to the modification.

For example, the trailer detection reliability calculated by the reliability calculation unit 24A3 is smaller than a predetermined threshold value stored in the memory 21. In this case, the visualization application processing unit 26 generates a mapping display screen W5 on which an indicator IG3 indicating a predetermined area AR1 (for example, the parking space PKS) including the position (for example, any position of the parking space PKS) at which the trailer is detected and a moving line FLW3 from the check-in gate CIG to the detected position are superimposed and drawn on the overhead map MP1 of the yard YRD, based on the visualization request from the displayer 30. The area AR1 is drawn in a single color, for example. The indicator IG3 notifies, for example, the trailer ID “ID0001” of the trailer, which is the target of the visualization request, and information indicating the area AR1 including a position estimated as the current position (for example, information indicating “AreaS” which is identification information of the parking space PKS) in association with each other. The visualization application processing unit 26 outputs (transmits) the generated mapping display screen W5 to at least the displayer 30, which is a transmission source of the visualization request (see FIG. 21). Accordingly, even in a situation in which the trailer position detection is difficult, such as when the trailer detection reliability is smaller than the predetermined threshold value, the trailer tracking apparatus 20A can visualize in a wide range an area having a high skull in which the trailer is positioned, and can visually present the area to the operator or the yard jockey.

For example, the trailer detection reliability calculated by the reliability calculation unit 24A3 is smaller than a predetermined threshold value stored in the memory 21. In this case, the visualization application processing unit 26 generates a mapping display screen W6 on which the indicator IG3 indicating a predetermined area AR1a (for example, the parking space PKS) including the position (for example, any position of the parking space PKS) at which the trailer is detected and the moving line FLW3 from the check-in gate CIG to the detected position are superimposed and drawn on the overhead map MP1 of the yard YRD, based on the visualization request from the displayer 30. For example, the area AR1a is drawn in a thin color because a probability of being parked is low in the vicinity of a terminal end and is drawn in a dark color because the probability of being parked in the vicinity of the center increases from the vicinity of the terminal end. The indicator IG3 notifies, for example, the trailer ID “ID0001” of the trailer, which is the target of the visualization request, and information indicating the area AR1a including the position estimated as the current position (for example, the information indicating “AreaS” which is the identification information of the parking space PKS) in association with each other. The visualization application processing unit 26 outputs (transmits) the generated mapping display screen W6 to at least the displayer 30, which is a transmission source of the visualization request (see FIG. 22). Accordingly, even in the situation in which the trailer position detection is difficult, such as when the trailer detection reliability is smaller than the predetermined threshold value, the trailer tracking apparatus 20A can suggest and visualize in a wide range a magnitude of a detection probability in the area having a high skull in which the trailer is positioned, and can visually present the area to the operator or the yard jockey.

For example, the trailer detection reliability calculated by the reliability calculation unit 24A3 is smaller than a predetermined threshold value stored in the memory 21. In this case, the visualization application processing unit 26 generates a mapping display screen W7 on which an indicator IG4 suggesting the position (for example, any position of the parking space PKS) at which the trailer is detected and a moving line FLW4 from the check-in gate CIG to a position at which the trailer is estimated to exist are superimposed and drawn on the overhead map MP1 of the yard YRD, based on the visualization request from the displayer 30. The indicator IG4 notifies, for example, at least the trailer ID “ID0001” of the trailer which is a target of the visualization request. The visualization application processing unit 26 outputs (transmits) the generated mapping display screen W7 to at least the displayer 30, which is the transmission source of the visualization request (see FIG. 23).

Accordingly, even in the situation in which the trailer position detection is difficult, such as when the trailer detection reliability is smaller than the predetermined threshold value, the trailer tracking apparatus 20A can visualize the vicinity of an area having a high skull in which the trailer is positioned so as to be able to be roughly presented, and can visually present the area to the operator or the yard jockey.

For example, the trailer detection reliability calculated by the reliability calculation unit 24A3 is smaller than a predetermined threshold value stored in the memory 21. In this case, the visualization application processing unit 26 generates a mapping display screen W8 on which an indicator IG5a suggesting the position (for example, any position of the parking space PKS) at which the trailer is detected and a moving line FLW5a from the check-in gate CIG to a position at which the trailer is estimated to exist are superimposed and drawn on the overhead map MP1 of the yard YRD, based on the visualization request from the displayer 30. The indicator IG5a notifies, for example, the trailer ID “ID0001” of the trailer which is the target of the visualization request, and the fact that the trailer detection reliability is relatively low (CS: low level).

For example, the trailer detection reliability calculated by the reliability calculation unit 24A3 is greater than the predetermined threshold value stored in the memory 21. In this case, the visualization application processing unit 26 generates the mapping display screen W8 on which an indicator IG5b suggesting the position (for example, any position of the parking space PKS) at which the trailer is detected and a moving line FLW5b from the check-in gate CIG to the position at which the trailer is estimated to exist are superimposed and drawn on the overhead map MP1 of the yard YRD, based on the visualization request from the displayer 30. The indicator IG5b notifies, for example, the trailer ID “ID0001” of the trailer which is the target of the visualization request, and the fact that the trailer detection reliability is relatively high (CS: high level).

The visualization application processing unit 26 outputs (transmits) the generated mapping display screen W8 to at least the displayer 30, which is the transmission source of the visualization request (see FIG. 24). Accordingly, even in the situation in which the trailer position detection is difficult, such as when the trailer detection reliability is smaller or greater than the predetermined threshold value, the trailer tracking apparatus 20A can flexibly change a thickness of the moving line depending on the magnitude of the position detection accuracy (trailer detection reliability) of the trailer and visualize the moving line, and can visually present the moving line to the operator or the yard jockey.

As described above, in the trailer tracking apparatus 20A according to the modification, the trailer moving line extraction unit 24A calculates the trailer reliability (trailer detection reliability) based on the captured images of the second cameras (trailer tracking cameras C1 to C8).

The visualization processing unit (visualization application processing unit 26) changes the display mode (see FIGS. 21 to 24) of the area indicator in the yard suggesting the current position of the trailer specified by the visualization instruction from the external browser apparatus (displayer 30) based on the calculation result of the reliability and outputs the display mode to the external browser apparatus. Thereby, the trailer tracking apparatus 20A can visually present to the operator or the yard jockey a probability that the trailer is being detected according to the magnitude of the trailer detection reliability.

Although various embodiments have been described above with reference to the accompanying drawings, the present disclosure is not limited thereto. It is apparent to a person skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, components in the various embodiments described above may be combined freely in a range without deviating from the spirit of the disclosure.

In the first embodiment or the modification thereof described above, when the trailer tracking apparatuses 20 and 20A detect the trailer using each of the trailer tracking cameras C1 to C8, the trailer moving line extraction units 24 and 24A may exclude objects other than the trailer from the detection targets. Each of the trailer tracking cameras C1 to C8 may be equipped with a learning model capable of detecting the trailer, and the trailer may be detected using the learning model and transmitted to the trailer tracking apparatuses 20 and 20A. Accordingly, the trailer tracking apparatuses 20 and 20A can omit processing of detecting the trailer.

The present disclosure is useful in a trailer tracking apparatus, a trailer tracking system, and a trailer tracking method for efficiently assisting a worker in a yard to easily visualize a position of a target trailer.

What is claimed is:

1. A trailer tracking apparatus comprising:
an acquisition unit configured to acquire, from at least one camera configured to capture an image of a predetermined movement path of a trailer in a yard, a captured image of the camera;
a database configured to store identification information on the trailer and information on a position of the trailer in the yard based on the captured image of the camera in association with each other; and
a visualization processing unit configured to output information on a current position of the trailer specified by a visualization instruction from an external browser apparatus to the external browser apparatus based on the database.

2. The trailer tracking apparatus according to claim 1, further comprising:
a pairing processing unit configured to associate the identification information on the trailer with the information on the position of the trailer in the yard based on the captured image of the camera.

3. The trailer tracking apparatus according to claim 1, wherein
the camera includes a first camera provided at an entrance of the yard and configured to read the identification information on the trailer, and
the trailer tracking apparatus further includes a trailer ID extraction unit configured to extract the identification information on the trailer based on a captured image of the first camera.

4. The trailer tracking apparatus according to claim 1, wherein
the camera includes at least one second camera provided in the yard and configured to capture an image of the movement path, and
the trailer tracking apparatus further includes a trailer moving line extraction unit configured to estimate the position of the trailer in the yard, and to extract a moving line of the trailer which is determined by an estimated position of the trailer for each time in the yard, based on a captured image of the second camera.

5. The trailer tracking apparatus according to claim 4, wherein
the trailer moving line extraction unit is configured to:
add a moving line up to the first position to an extracted moving line, when determining that a first position indicating the position of the trailer in the yard based on the captured image of the second camera is within a prediction range, and
add the moving line up to the first position as a new moving line, when determining that the first position indicating the position of the trailer in the yard based on the captured image of the second camera is not within the prediction range.

6. The trailer tracking apparatus according to claim 1, wherein
the visualization processing unit is configured output, to the external browser apparatus, the current position of the trailer specified by the visualization instruction and a moving line indicating a movement trajectory in the yard to the current position in association with each other.

7. The trailer tracking apparatus according to claim 6, further comprising:
a second database configured to store information on a position on the movement path for each time in the yard of the trailer, wherein
the visualization processing unit is configured to output, to the external browser apparatus, the current position of the trailer specified by the visualization instruction and a position at which the trailer is to be parked at a current time comparatively.

8. The trailer tracking apparatus according to claim 4, wherein
the trailer moving line extraction unit is configured to calculate reliability of the trailer based on the captured image of the second camera, and
the visualization processing unit is configured to change, based on a calculation result of the reliability, a display mode of an area indicator in the yard which suggests the current position of the trailer specified by the visualization instruction from the external browser apparatus and to output the display mode to the external browser apparatus.

9. A trailer tracking method executed by a trailer tracking apparatus communicably connected to at least one camera configured to capture an image of a predetermined movement path of a trailer in a yard, the trailer tracking method comprising:
acquiring a captured image of the camera from the camera;
storing identification information on the trailer and information on a position of the trailer in the yard based on the captured image of the camera in the database in association with each other; and
outputting information on a current position of the trailer specified by a visualization instruction from an external browser apparatus to the external browser apparatus based on the database.

10. A trailer tracking system comprising:
at least one camera configured to capture an image of a predetermined movement path of a trailer in a yard;
an acquisition unit configured to acquire a captured image of the camera;
a database configured to store identification information on the trailer and information on a position of the trailer in the yard based on the captured image of the camera in association with each other; and
a visualization processing unit configured to output information on a current position of the trailer specified by a visualization instruction from an external browser apparatus to the external browser apparatus based on the database.
